(19) United States
(12) Patent Application Publication
(10) Pub. No.: US 2006/0190325 A1
(43) Pub. Date: Aug. 24, 2006

(54) No-fee, Internet, marketing system with new-member, introducer identification

(76) Inventor: David J. Tarsh, London (GB)

Correspondence Address: NEEDLE & ROSENBERG, P.C., SUITE 1000, 999 PEACHTREE STREET, ATLANTA, GA, 30309-3915, US

(21) Appl. No.: 11/286,183

(22) Filed: Nov. 23, 2005

Related U.S. Application Data
(60) Provisional application No. 60/630,783, filed on Nov. 23, 2004.

(51) Int. Cl. G06Q 30/00

(52) U.S. Cl. 705/14

(57) ABSTRACT

Methods, systems, and computer program products are provided for various embodiments directed to a novel network marketing system. In one embodiment of the present invention, the network marketing method is free to join and rewards participants with real money based on recommended product purchases. Rules are provided in various embodiments which define the operation of the various network marketing methods. Furthermore, a particular application of the present invention directed to the travel industry is provided as an illustrative embodiment enabling one of skill in the art to make and use the present invention.

### CROSS-REFERENCE TO RELATED PATENT APPLICATIONS

This application claims priority under 35 U.S.C. §119 to U.S. Provisional Patent Application Ser. No. 60/630,783, entitled “NO-FEE, INTERNET, MARKETING SYSTEM WITH NEW-MEMBER, INTRODUCER IDENTIFICATION” filed on Nov. 23, 2004, which is herein incorporated by reference in its entirety.

### TECHNICAL FIELD OF THE INVENTION

The present invention provides systems, methods, and computer program products for marketing on the Internet. The various embodiments of the present invention address network marketing in novel ways by rewarding consumer purchases based on purchase recommendations with cash rewards. Various embodiments of the present invention also offer marketers the possibility of tracking and rewarding ‘word of mouth’ recommendations.

### SUMMARY OF THE INVENTION

The systems, methods, and computer program products of the present invention (hereinafter “method” or “methods”) enable marketers to track and reward consumers who recommend the marketers' products and services to others. Likewise, the methods of the present invention enable consumers to earn real money simply and legitimately by recommending a product or service to others.

The referral rewards of the present invention related directly to the amount of business attributable to each individual who participates. Businesses using the present invention gain the potential to significantly reduce promotional costs and to penetrate markets that would otherwise be very difficult to reach in a cost effective manner using conventional techniques. The present invention also provides a data protection compliant means of building a database of new prospective customers. This is highly significant in today's environment of strict regulation of database marketing activities. Furthermore, the present invention also can significantly increase customer loyalty when the rewards are used to purchase the products and services of the company using the system.

In various embodiments of the present invention, there is no subscription fee or joining fee so there is no cost and consequently no chance for a participant to loose money as a consequence of participating. Since the cost disincentive to joining presented by virtually all network-marketing systems is removed, there is no liability to provide any refund should a participant subsequently decide to withdraw. While various embodiments of the present invention reward participants with currency, other embodiments may also provide other types of reward values, such as points.

A fundamental principle of present invention is that rewards are tied to actual sales, not merely to introductions or referrals, which ensures that the programme has commercial integrity. Furthermore, the higher the value of the sales is, the higher the reward that will be paid on an explicit basis. Consequently, the present invention is less likely to result in commission disputes or unduly burdensome commission payments associated with the dispute. Moreover, paying commission only for complete purchase transactions instead of merely allowing credit to pass in exchange for signing up others or for viewing advertising has the potential to eliminate the risk of organizational and personal bankruptcy as a direct consequence of employing the system.

In various embodiments of the present invention, no credit passes between participants; it all flows from the centre and the commercial relationship exists with the person or organisation using (or promoting) this business system and with each participant. This commercial structure ensures consistency and eliminates grounds for commercial dispute between participants.

In some embodiments of the present invention, commission can be used to purchase the products and/or services of the business deploying the business system. As a consequence, there would be an incentive for participants not to claim the commission in order to use it on a subsequent purchase. This will have strong cash flow and loyalty advantages for the business using the system.

While various embodiments of the present invention may be used for the marketing of a portfolio of products and services provided by one company, it is conceivable that it could be deployed on behalf of several different businesses or on behalf of one business selling only one product.

Other goals, features, and advantages of the present invention will become apparent upon reviewing the following detailed description of the preferred embodiments of the invention, when taken in conjunction with the drawings and the appended claims.

### BRIEF DESCRIPTION OF THE DRAWINGS

The accompanying drawings, which are incorporated in and constitute part of this specification, illustrate embodiments of the invention, and together with the description, serve to explain the principles of the invention. The embodiments described in the drawings and specification in no way limit or define the scope of the present invention.

FIG. 1 shows a logical overview of a computer system which may be used to carry out the various embodiments of the present invention.

FIG. 2 illustrates one system for implementing the methods of the present invention.

FIG. 3 illustrates the network marketing method of one embodiment of the present invention.

FIG. 4 illustrates the network marketing method of another embodiment of the present invention.

FIG. 5 shows a flow diagram of the booking process of one embodiment of the present invention.

FIG. 6 shows a flow diagram of the account administration procedure of one embodiment of the present invention.

FIG. 7 shows a flow diagram of a call centre method of one embodiment of the present invention.

FIG. 8 shows the network marketing method of yet another embodiment of the present invention.

FIG. 9 shows the network marketing method of a further embodiment of the present invention.

FIG. 10 illustrates the website layout of one embodiment of the present invention.

FIG. 11 shows a screen capture of the International Home Page of one embodiment of the present invention.

FIG. 12 shows a screen capture of the Regional Home Page of one embodiment of the present invention.

FIG. 13 shows a screen capture of the More about the Club Page of one embodiment of the present invention.

FIG. 14 shows a screen capture of the FAQ Page of one embodiment of the present invention.

FIG. 15 shows a screen capture of the Registration Pages of one embodiment of the present invention.

FIG. 16 shows a screen capture of the Registration Details Page of one embodiment of the present invention.

FIG. 17 shows a screen capture of the Registration Complete Page of one embodiment of the present invention.

FIG. 18 shows a screen capture of the Registration Complete with No Introducer Page of one embodiment of the present invention.

FIG. 19 shows a screen capture of the Already Registered Page of one embodiment of the present invention.

FIG. 20 shows a screen capture of the Local Home Page of one embodiment of the present invention.

FIG. 21 shows a screen capture of the Login Page of one embodiment of the present invention.

FIG. 22 shows a screen capture of the My Commission Page of one embodiment of the present invention.

FIG. 23 shows a screen capture of the Claim My Commission Page of one embodiment of the present invention.

FIG. 24 shows a screen capture of the Update/Change My Profile Page of one embodiment of the present invention.

FIG. 25 shows a screen capture of the Introduce Family or Friends Page of one embodiment of the present invention.

FIG. 26 shows a screen capture of the Network Search Page of one embodiment of the present invention.

FIG. 27 shows a screen capture of the Your Bookings Page of one embodiment of the present invention.

FIG. 28 illustrates how introducers are selected in one embodiment of the present invention.

FIG. 29 shows a Payments Header File of one embodiment of the present invention.

FIG. 30 shows a Commission Payment Breakdown of one embodiment of the present invention.

FIG. 31 shows a screen capture of the Registration Confirmation Email of one embodiment of the present invention.

FIG. 32 shows a screen capture of the Registration Confirmation Email (No Introducer) of one embodiment of the present invention.

FIG. 33 shows a screen capture of the No Introducer Reminder Email of one embodiment of the present invention.

FIG. 34 shows a screen capture of the Introducer Email of one embodiment of the present invention.

FIG. 35 shows a screen capture of the Forgot Password Email of one embodiment of the present invention.

FIG. 36 shows a screen capture of the Pending Commission Email of one embodiment of the present invention.

FIG. 37 shows a screen capture of the Resign Confirmation Email of one embodiment of the present invention.

FIG. 38 shows a logical flow diagram for the Customer Service web page flow of one embodiment of the present invention.

FIG. 39 shows a screen capture of the Find Travel Club Member Page of one embodiment of the present invention.

FIG. 40 shows a screen capture of the Member List Page of one embodiment of the present invention.

FIG. 41 shows a screen capture of the Security Details Page of one embodiment of the present invention.

FIG. 42 shows a screen capture of the Member Details Page of one embodiment of the present invention.

FIG. 43 shows a screen capture of the Member Commission Pending Page of one embodiment of the present invention.

FIG. 44 shows a screen capture of the Member Commission Earned Page of one embodiment of the present invention.

FIG. 45 shows a screen capture of the Member Commission Paid Page of one embodiment of the present invention.

FIG. 46 shows a screen capture of the Member Commission Breakdown Page of one embodiment of the present invention.

FIG. 47 shows a screen capture of the Member Commission Links Page of one embodiment of the present invention.

FIG. 48 shows a screen capture of the Network Search Page of one embodiment of the present invention.

FIG. 49 shows a screen capture of the Network Results List Page of one embodiment of the present invention.

FIG. 50 shows the network marketing method of yet a further embodiment of the present invention.

### DETAILED DESCRIPTION

Before the present methods, systems, and computer program products are disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an encoder” includes mixtures of encoders, reference to “an encoder” includes mixtures of two or more such encoders, and the like.

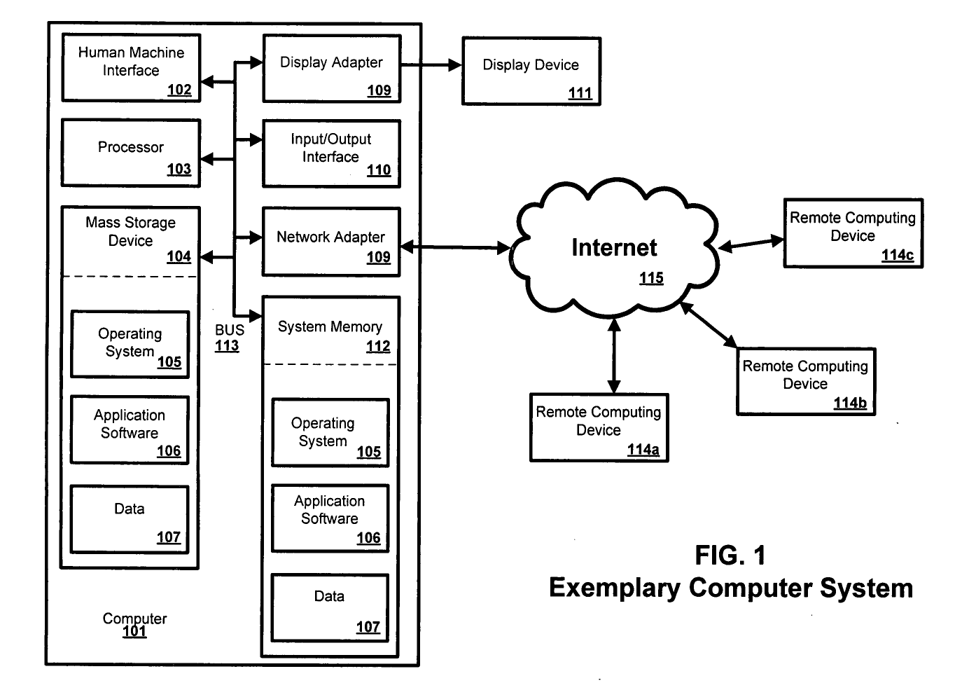

The system, method, and computer program product of the present invention, collectively referred to herein as the “method” or “methods” of the present invention can be carried out using a processor programmed to carry out the various embodiments of the present invention. FIG. 1 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Examples of well known computing systems, environments, and/or configurations that may be suitable for use with the method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The method may be described in the general context of computer instructions, such as program modules, being executed by a computer. Generally, program modules include routines, programs, objects, components, data structures, etc. that perform particular tasks or implement particular abstract data types. The method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 101. The components of the computer 101 can include, but are not limited to, one or more processors or processing units 103, a system memory 112, and a system bus 113 that couples various system components including the processor 103 to the system memory 112.

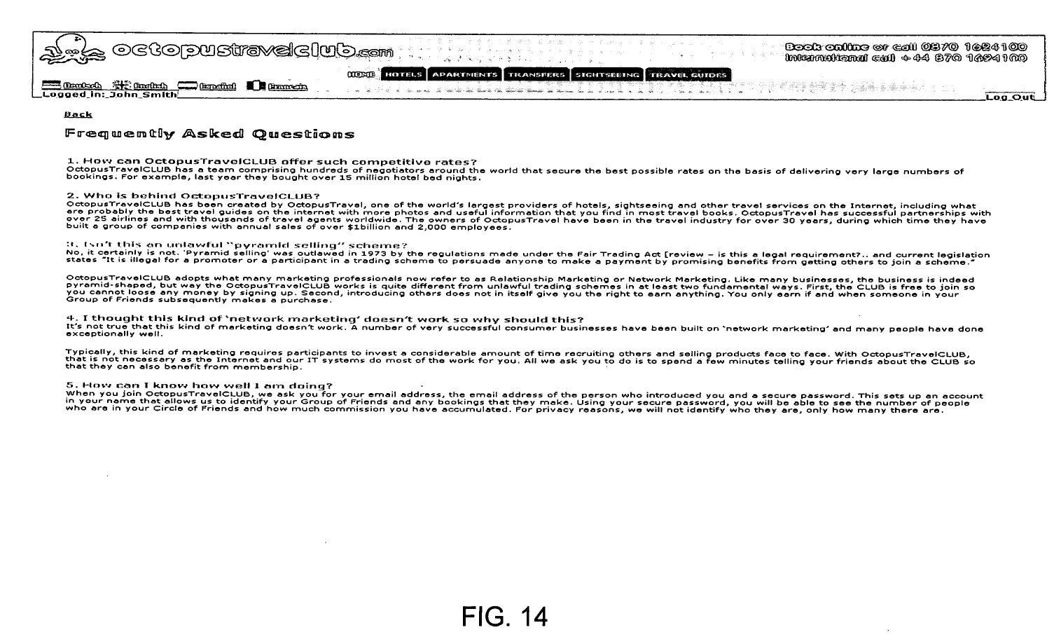

The processor 103 in FIG. 14 can be an x-86 compatible processor, including a PENTIUM IV, manufactured by Intel Corporation, or an ATHLON 64 processor, manufactured by Advanced Micro Devices Corporation. Processors utilizing other instruction sets may also be used, including those manufactured by Apple, IBM, or NEC.

The system bus 113 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 113, and all buses specified in this description can also be implemented over a wired or wireless network connection and each of the subsystems, including the processor 103, a mass storage device 104, an operating system 105, application software 106, data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The operating system 105 in FIG. 1 includes operating systems such as MICROSOFT WINDOWS XP, WINDOWS 2000, WINDOWS NT, or WINDOWS 98, and REDHAT LINUX, FREE BSD, or SUN MICROSYSTEMS SOLARIS. Additionally, the application software 106 may include web browsing software, such as MICROSOFT INTERNET EXPLORER or MOZILLA FIREFOX, enabling a user to view HTML, SGML, XML, or any other suitably constructed document language on the display device 111.

The computer 101 typically includes a variety of computer readable media. Such media can be any available media that is accessible by the computer 101 and includes both volatile and non-volatile media, removable and non-removable media. The system memory 112 includes computer readable media in the form of volatile memory, such as random access memory (RAM), and/or non-volatile memory, such as read only memory (ROM). The system memory 112 typically contains data such as data 107 and and/or program modules such as operating system 105 and application software 106 that are immediately accessible to and/or are presently operated on by the processing unit 103.

The computer 101 may also include other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 104, including by way of example, an operating system 105 and application software 106. Each of the operating system 105 and application software 106 (or some combination thereof) may include elements of the programming and the application software 106. Data 107 can also be stored on the mass storage device 104. Data 104 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 101 via an input device (not shown). Examples of such input devices include, but are not limited to, a keyboard, pointing device (e.g., a “mouse”), a microphone, a joystick, a serial port, a scanner, touch screen mechanisms, and the like. These and other input devices can be connected to the processing unit 103 via a human machine interface 102 that is coupled to the system bus 113, but may be connected by other interface and bus structures, such as a parallel port, serial port, game port, or a universal serial bus (USB).

A display device 111 can also be connected to the system bus 113 via an interface, such as a display adapter 109. For example, a display device can be a cathode ray tube (CRT) monitor or an Liquid Crystal Display (LCD). In addition to the display device 111, other output peripheral devices can include components such as speakers (not shown) and a printer (not shown) which can be connected to the computer 101 via Input/Output Interface 110.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of application software 106 may be stored on or transmitted across some form of computer readable media. An implementation of the disclosed method may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It will be apparent to those skilled in the art that various digital devices may be used to carry out the systems, methods, and computer program products of the present invention, such as a self service station, kiosk, point of sale terminal, interactive customer display, personal computer, set top box, personal digital assistant, cell phone, or dedicated hardware devices designed specifically to carry out the methods of the present invention. Furthermore, while various embodiments provided in the current application refer to the statutory classes of methods, systems, or computer program products, it should be noted that the present invention may be carried out, embodied, or claimed in any statutory class.

Unless otherwise expressly stated, it is in no way intended that any method or embodiment set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

One embodiment of the present invention provides a method of going to market using the Internet for registration and a central database in such a way that referral by one consumer to another can be tracked and rewarded with the payment of commission if and when the referral leads to a purchase. Purchase is made (preferably but not necessarily on a website) where the participant is identified as a participant. This may be achieved by logging on at the start of a transaction or by inputting details as a participant during the purchase process.

In the various embodiments of the present invention, methods are provided which allow participants to forward an email or communicate in some other way to explain the benefits of membership to others. New participants register themselves using the website. When they do so, in one embodiment, they provide the name of the introducing member at (or soon after) registration. Failure to provide the name of the introducing member does not prevent registration. In one embodiment, the introducer is designated as the promoter or business employing the system.

In the various embodiments, the new member accepts specific rules at the moment of sign up, including not spamming, not seeking to earn commission on his own purchase, not undermining the integrity of the scheme, not bringing the scheme in to disrepute, a threshold for payment, liability to declare any earnings to relevant taxation authorities, and so on.

No financial outlay is needed to participate in various embodiments of the present invention. As there is no financial outlay needed by participants, there is therefore no potential for financial loss. In one embodiment of the present invention, participants have an account for accumulating commission and are able to claim commission once the value passes a given threshold. Further, once participants have joined, they receive an email encouraging them to recruit others.

There is no requirement in the various embodiments that the purchase recommendations be spread by any specific means (e.g., email), as the giving of the name of an introducer who is already a participant is sufficient, thereby facilitating the tracking of purchase recommendations communicated by any means, such as ‘word-of-mouth’ recommendations.

In one embodiment, the present invention is operated as a website which may be operative on the computer system of FIG. 1. In the current embodiment, a section of a web site operating the present invention facilitates the recruitment of others by email and provides suggested text that carries a means of identifying the introducer to pre-populate the sign up page when a new participant who has received the email registers. In yet another embodiment, methods are provided which allow the use of a club or similar membership arrangement in which participants can earn commission on purchases made by others within their Circle of Friends. A Circle of Friends comprises all the new participants a specific participant introduces plus all the people that they introduce, and so on, up to a specified number of ripples. Each ripple represents new introductions of equivalent proximity to a given participant.

Other sections of the web site carry details of the company using the system, an explanation of the system, answers to frequently asked questions, terms and conditions, tools for administering one's own account, and pages allowing limited interrogation of one's own Circle of Friends.

When a purchase is made in one embodiment, an email is automatically sent to each commission earner notifying them of their potential earnings and encouraging them to recruit others. The chain of referral is tracked by virtue of the new participant naming the participant who made the introduction when (or soon after) the new participant joins. Participants are further able to track commission pending, earned and claimed, and the size of their Circle of Friends, on-line via their own password protected account.

In one embodiment, commission is paid to participants according to the volume of business each has helped generate and the proximity, within a certain number of specified ripples, to the participant making the transaction. Each commission payment can be related to a specific transaction so the amount due to each participant for each transaction is transparent.

In some embodiments of the present invention, participants are rewarded in a selected currency or “real cash.” Other embodiments can reward consumers using one or more types of reward value, including currency, points, incentives, special offers, discounts, frequent flier miles, free product, free service, credit, and Credit Funds Transfer (CFT). CFT provides payment back to a participant's credit card without the need for an initial purchase transaction. Rewards may also include the creation and posting of cheques, any means of direct payment in to participants' bank accounts or other accounts such as a charge card, depositing of funds in a third party account, such a charity account or a PayPal account, or use of the commission as credit against future purchases of the products and/or services promoted by the system.

In various embodiments of the present invention, rules are provided which define how the invented system accomplishes many of the above-listed features. Some of the generalized rules are described in the following paragraphs, but can be system tailored depending on the type of implementation. For example, a particular set of rules can be used for the travel industry. The rules for a particular embodiment can define key aspects of the invention, including the introducer, introductions, recommendation policies and methods, how rewards are computed, what value rewards are provided in, and how those rewards are taxed, among other aspects.

### Introducer Rule

The introducer is the member whom is named by a new member at the point of joining. Consequently, the onus is on the new participant to make the connection back to the introducing participant in various embodiments of the present invention. Using the current embodiment, a new participant can proactively identify the introducer by supplying the introducer's email address. Alternatively, the introducer can implicitly identify the introducer by connecting to the a website by activating a link in a forwarded email from the introducer with an embedded identification code.

### Introductions Rule

In some embodiments of the present invention, members may only introduce people they already know personally. This rule enhances system integrity by not contravening email marketing legislation in some countries and giving rise to disputes over future commissions where more than one participant provides the email address of a prospective member who later joins.

### Solicitation Rule

Sending unsolicited Email to people one does not know personally is expressly forbidden and can result in expulsion of the participant. This is an important rule to protect the integrity and reputation of the business system.

### Rewards Rule

Rewards are based on completed transactions. This rule facilitates compliance in some markets with ‘trading schemes’ where rewarding others simply for making introductions are either unlawful or very tightly regulated. Furthermore, such ‘trading schemes’ are not commercially sustainable. Consequently, the present invention provides a commercially sustainable business solution.

### Tax Rule

Participants are responsible for their own tax in some embodiments of the present invention. As the present invention can operate anywhere in the world, as rewards could be large or small and as participants claim them, it is each participant's responsibility for their own tax. The only exceptions to this are employees of the business using the present invention. In their case, tax is handled by the business as part of the payroll function when commission is claimed.

### Communications Rule

In various embodiments of the present invention the network marketing methods are presented as a club or association with members. The term ‘club’ suggests special benefits for members, shared benefit, and social contact between people with similar interests. However, an alternative implementation is possible, using customer, employee, or other defined groups or merely direct proposal by a promoter of the present invention.

### Systems and Data Flow

An overview description of the systems and data flow used to operate one embodiment of the present invention is provided below. The described embodiment(s) are for illustrative purposes only and in no way to limit or define the scope of the invention.

One embodiment of the present invention may be carried on a website operating on the computer system illustrated in FIG. 1. The website can include a plurality of web pages and functionalities, such as pages explaining the system, sign up pages, links to product pages (on this or another site), pages to assist members to recruit family and friends, system rules, frequently asked questions, a variety of pages containing searches to query or change the underlying database, as well as automated emails triggered by a various events. Various embodiments may also include a database for storing and tracking member information

The web server of the current embodiment may be accessed by a client computer operating on the computer system illustrated in the embodiment of FIG. 1. In the current embodiment, a new member first registers to join on a central website and at the moment of registration provides the name of the introducing member. In an alternative implementation, a member can identify an introducer for a pre-selected time period after registration. Second, registration pages collect appropriate personal information, including name, email address, selected password and other information, which is then stored in a central database. The registration pages also contain the opt-in to receive marketing messages and acceptance of the terms and conditions. Email body text is also offered to participants that can be used to refer others to the web site. This text carries a unique identifier so that when the recipient of an email carrying such text commences the registration process, the email address of the introducing member pre-populates the ‘introducer’ field. Participants may also select how often they receive different types of email.

Third in the current embodiment, emails are triggered automatically to encourage members to spread the word to others. They happen at successful sign-up, upon notification that commission has been earned, and when it is claimed. Next, when a purchase takes place, commission is allocated to a chain of introducers who are qualified by their proximity to the participant making the purchase.

In various embodiments, an account facility exists on the website where participants can amend their own personal details, monitor progress of their own Circle of Friends, and claim commission once it has exceeded a set threshold. In order to claim commission in one embodiment, the participant enters his bank account (in the USA) or credit card details (elsewhere) and the transaction is processed by ACH (in the USA) or by CFT (elsewhere). When claiming commission, there can also be the option of including the account details of a named charity or other type of account. As an optional alternative method, participants could make a selection from a number of charities on their own account page at the point of registration or any time after, for automatic donation.

The current embodiment may further provide a search functionality to identify whether a particular person is within the participant's Circle of Friends. A counter and database query can be used to identify the total number of people in a given participant's Circle of Friends.

In embodiments where operation of the system involves bookings (e.g. a hotel room) that could theoretically be cancelled, the system can provide methods to report commission pending. In such circumstances, when the booking is ‘consumed’ and payment passes, the commission becomes earned.

Customer service support pages and database queries enable customer services agents to look at a participant's account, to identify the chain of introducers, to interrogate each member's transaction history, and to track commission payments to specific transactions in various embodiments. Further, password protected data ensures that a member's account is only accessed by a member, a customer services agent talking to a member, or an administrator with sufficient security clearance.

One embodiment of the present invention provides for detailed system management reports. Detailed management reports include, but are not be limited to, daily number of new participants joining in total and by country, total sales by number, by value and by country, numbers of participants enrolled in total and by country, top five highest commission earners in total and by country and average and total commission pending, earned and claimed, which may be broken down by employees of the company using the system and by country. These reports are generated automatically. In alternative implementations, the level of detail in the report may vary.

### Illustrative System for Implementing the Invention

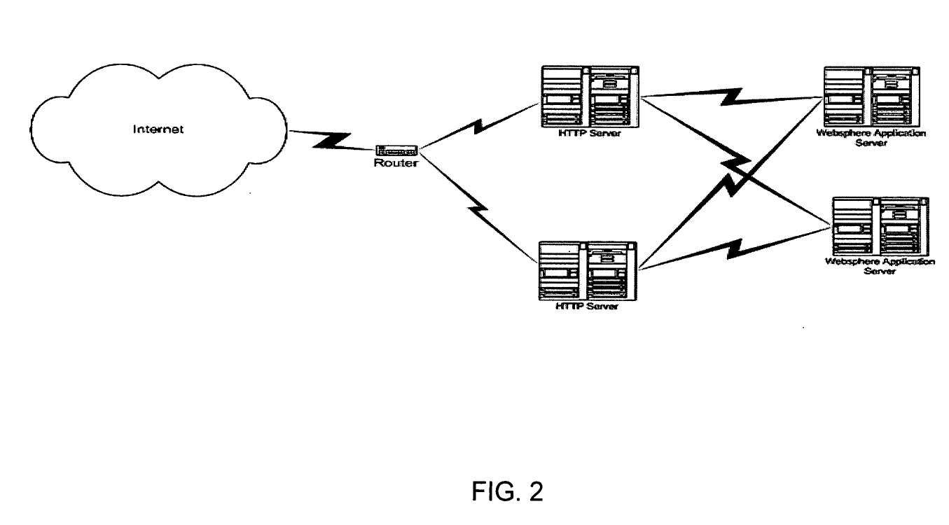

One implementation of the present invention illustrated in FIG. 2 may be based on applications that run on the IBM iSeries platform. The core of the system is java-based applications that are served by IBM Websphere Application Servers. Other system configurations are also contemplated. For example, one or more of severs could operate on a different platform, such as a Linux operating system operating on one or more Intel x86 processors as discussed with regard to the computer system embodied in FIG. 1.

### Data Flow

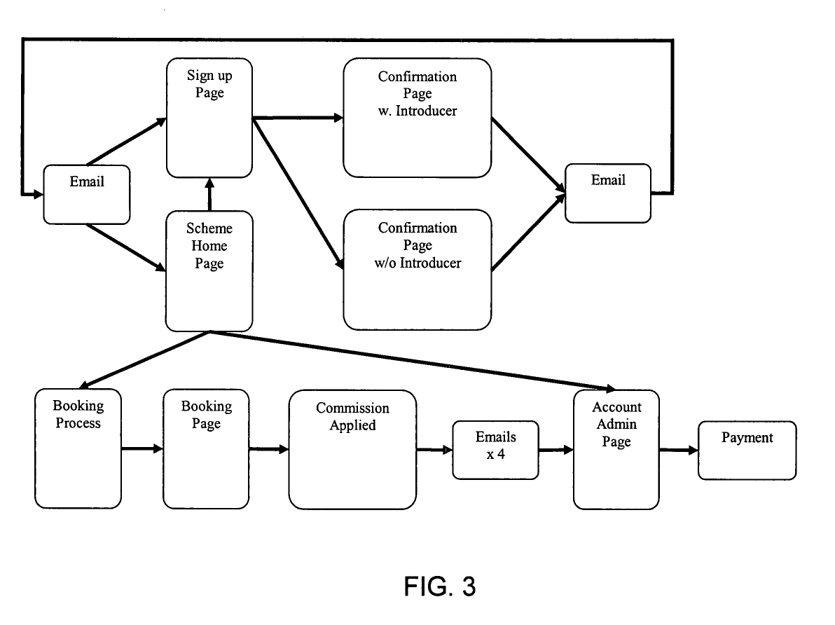

A simplified data flow diagram of one embodiment of the present invention is illustrated in FIG. 3. First, an email is sent from an introducer to a consumer 301. The email may have a link directing the consumer to a sign up page. The email may also contain information identifying the consumer's introducer, allowing the consumer to identify his introducer 304. In the alternative, the consumer may participate in the marketing system of the present invention without designating an introducer 305.

Returning to step 303, the consumer may receive an email and proceed to a home page residing on one or more web servers described in the various embodiments. The consumer may then initiate a booking process 307, and proceed to a booking page 308 where the consumer may book, for example, a hotel reservation. The current embodiment then computes and applies commissions for all participants in the introducer's Circle of Friends. Next, at step 310, automatic emails are sent notifying each participant that a purchase has been made and rewards earned. Each participant then receives payment at step 312.

### Registration

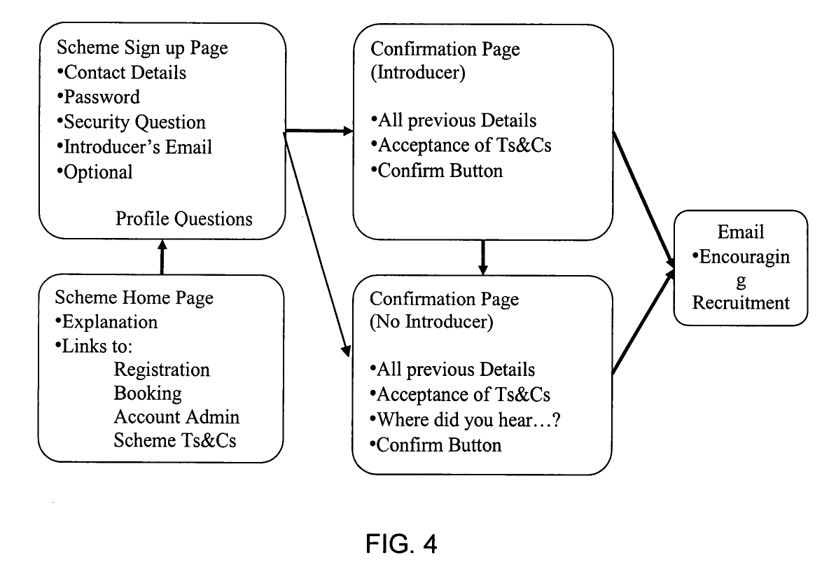

FIG. 4 illustrates a simplified flow diagram showing the registration process of one embodiment of the present invention. First, a potential participant views a home page explaining the benefits of the current network marketing system. Second, the user signs up to participate in the marketing system by providing information such as contact details, a password, and their introducer's email. Third, if the user knows their introducer, the user views a confirmation page where the user confirms their sign up information. In the alternative, if the user does not know their introducer, their previously entered details are confirmed, and the user prompted to entire where their learned of the marketing system. Finally, now that the user is a participant, they are sent an email which encourages them to recruit new members.

### Booking

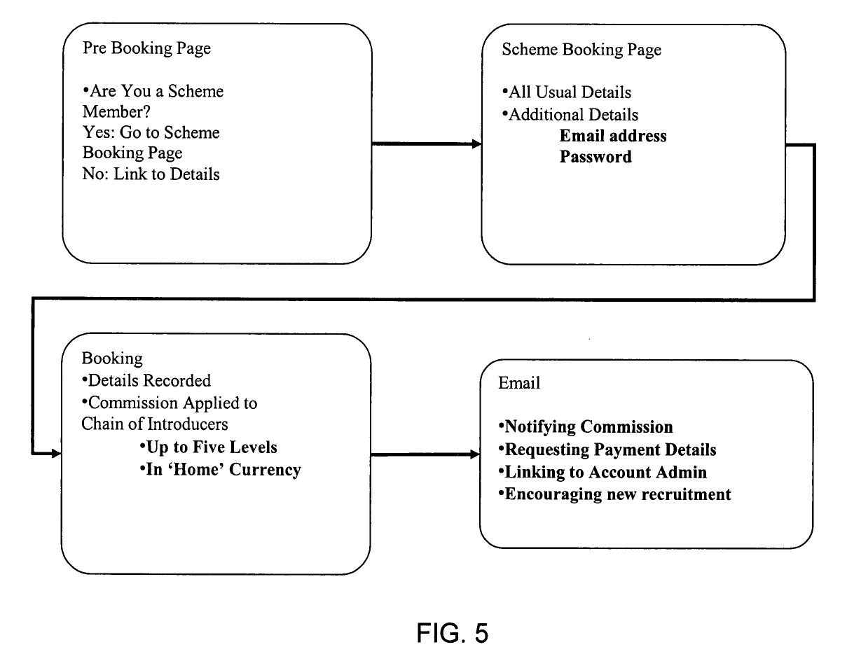

FIG. 5 illustrates a simplified flow diagram showing the booking process useful in various embodiments of the present invention. Bookings in the various embodiments may refer to the purchase of any type of good or service, including travel services. First, a user is presented with a pre booking page, which ask the user if they are a member of the network marketing system. Second, the user enters user information as well as an email address and password. Third, the user books a reservation, the booking details are recorded, and a commission is computed and applied to the relevant chain of introducers. In the current embodiment the chain of introducers includes five participants, who will each receive a reward based on the booking. Finally, an automated email is sent which notifies each participant in the chain of introducers of their commission, requests payment details, provides a link to an account administration page, and encourages further recruitment into the marketing system.

### Account Administration and Call Centre Support

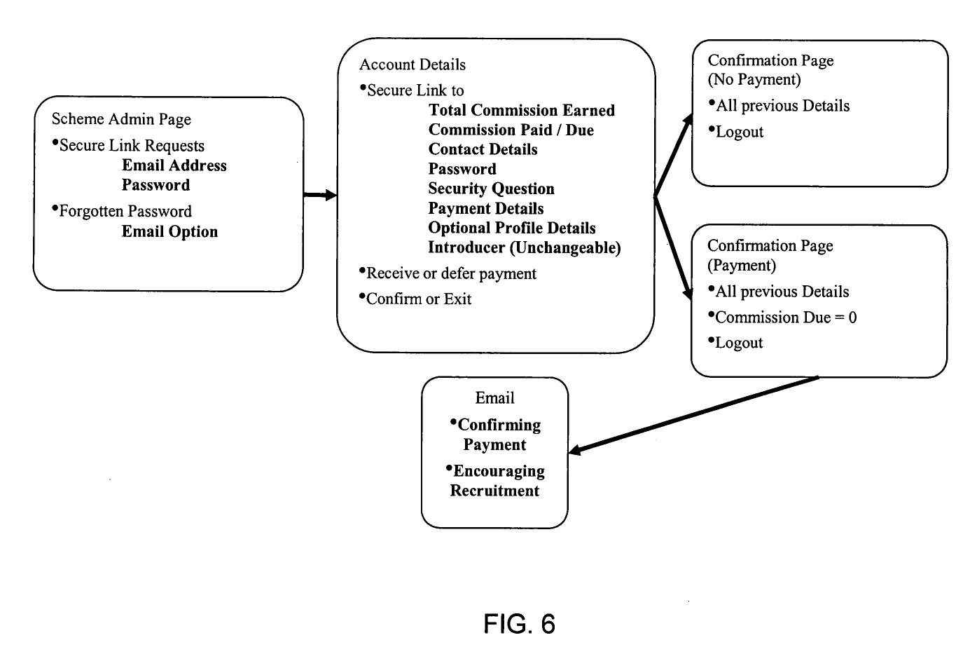

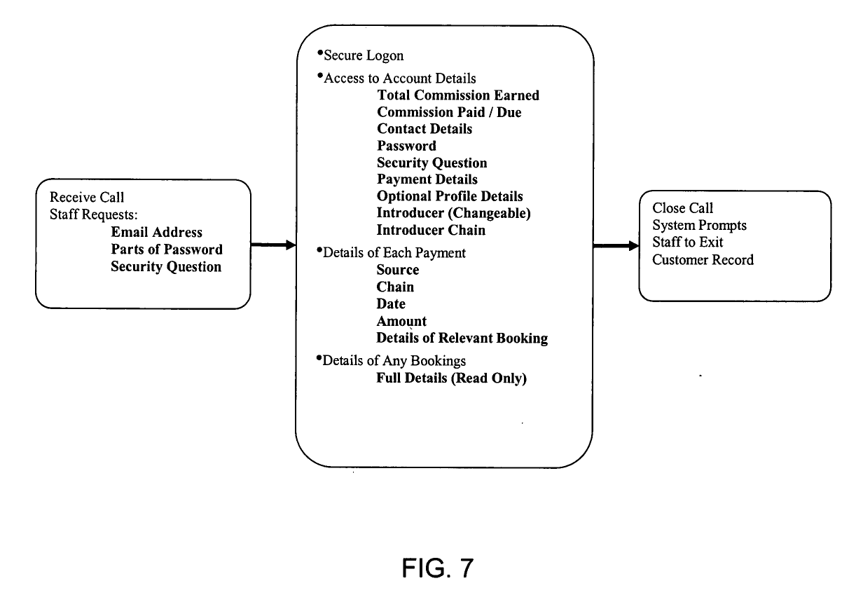

A flow diagram illustrating the logical operation of one embodiment of the account administration page referenced in various embodiments is presented in FIG. 6. Additionally, a flow diagram showing one embodiment of the logical flow of a call centre support method useful with various embodiments of the present invention is provided in FIG. 7.

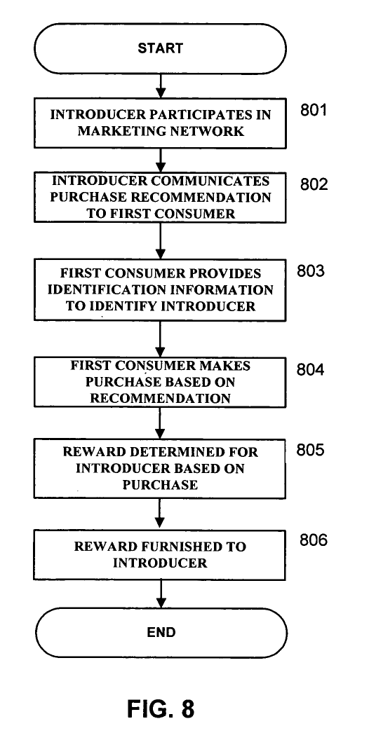

One embodiment of the present invention useful for network marketing is illustrated in the embodiment of FIG. 8. First in the embodiment of FIG. 8, an introducer participates in the network marketing system of the present invention 801. In various embodiments, it is free for the introducer to participate in the marketing network. Second, the introducer communicates a purchase recommendation to a first consumer 802. The purchase recommendation can be for a particular product, a product brand, a product vendor, or any combination thereof. The purchase recommendation can also be communicated in a variety of ways, including orally or electronically.

Third in the embodiment of FIG. 8, the first consumer provides identification information useful to identify the introducer 803. In various embodiments, identification information includes one or more of an email address, name, login, password, keyword, or any information which can be used to uniquely identify the first consumer's introducer. In various embodiments, the consumer operates a computing device of the kind illustrated in FIG. 1, and provides the introducer's identification information by inputting it into a web browser operating on the computing device.

Fourth, the consumer makes a purchase based on the introducer's purchase recommendation 804. In various embodiments, the consumer's purchase may be for any type of good or service, such as a travel service. In another embodiment, travel services include hotel booking, flight bookings, vacation package bookings, rail booking, cruise booking, and the like.

Fifth, the method of FIG. 5 determines a reward to provide to the introducer based on the first consumer's purchase 805. In one embodiment the reward is in the form of currency or “real money.” In other embodiments, the reward can include one or more of points, incentives, special offers, discounts, frequent flier miles, free product, free service, credit, Credit Transfer Funds, or currency.

The reward provided to the introducer may be a commission computed based on the value of the consumer's purchase in some embodiments. In another embodiment, the commission may be a cost of the consumer's purchase, such as two percent.

Finally, the method furnishes the reward to the introducer 806. In one embodiment, the reward is furnished to the introducer only if it exceeds a certain predetermined threshold, such as twenty-five British pounds. Additionally, the method of FIG. 8 may provide automatic email notification to the introducer notifying him or her that the first consumer has joined and named the introducer as the first consumer's introducer, that the first consumer make a purchase, and that a reward has been determined and furnished to the introducer.

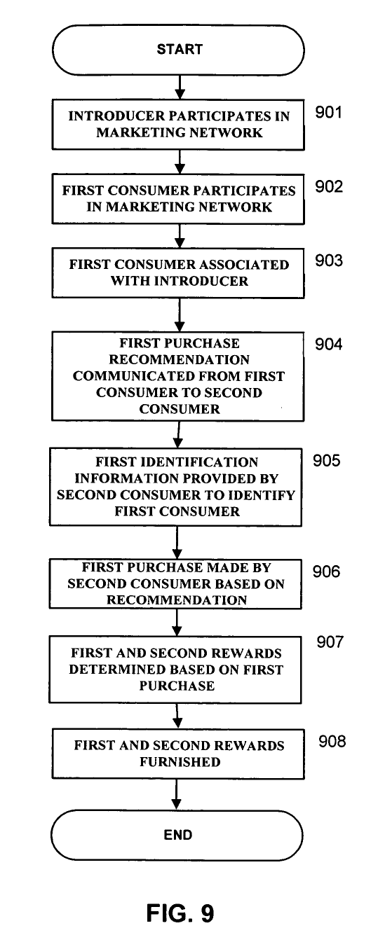

Another embodiment of the present invention useful for network marketing is illustrated in FIG. 9. First, in FIG. 9, an introducer participates in the network marking program of the present invention 901, and a first consumer participates in the network marking program 902. In one embodiment of the present invention, it is free for both the introducer and the fist consumer to participate.

Third, the first consumer is associated with the introducer 903. In one embodiment, the first consumer is associated with the introducer by providing a second identification information by the first consumer useful to identify the introducer, thereby associating the introducer with introducer. In another embodiment, the first consumer is associated with the consumer by communicating a second purchase recommendation from the introducer to the first consumer, making a second purchase by the first consumer based on the second purchase recommendation, providing a second identification information by the first consumer useful to identify the introducer, determining a third reward to provide to the introducer based on the second purchase, and furnishing the third reward to the introducer.

Fourth in the embodiment of FIG. 9, a first purchase recommendation is communicated from the first consumer to a second consumer 904. The first purchase recommendation can be for a particular product, a product brand, a product vendor, or any combination thereof. The first purchase recommendation can also be communicated in a variety of ways, including orally or electronically.

A first identification information is then provided by the second consumer, which is used to identify the first consumer 905. In various embodiments, identification information includes one or more of an email address, name, login, password, keyword, or any information which can be used to uniquely identify the first consumer's introducer. In further embodiments, the first consumer operates a computing device of the kind illustrated in FIG. 1, and provides the introducer's identification information by inputting it into a web browser operating on the computing device.

A first purchase is then made by the second consumer based on the purchase recommendation 906. In various embodiments, the first purchase may be for any type of good or service, such as a travel service. In another embodiment, travel services include hotel booking, flight bookings, vacation package bookings, rail booking, cruise booking, and the like.

Seventh, a first reward is determined to provide to the introducer based on the first purchase, and a second reward is determined to provide to the first consumer based on the first purchase 907. In one embodiment the first and second rewards are in the form of currency or “real money.” In other embodiments, the first and second rewards can each include one or more of points, incentives, special offers, discounts, frequent flier miles, free product, free service, credit, Credit Transfer Funds, or currency.

Finally in the embodiment of FIG. 9, the first reward is furnished to the introducer and the second reward is furnished to the first consumer 908. The reward provided to the introducer and the first consumer may each be a commission computed based on the value of the second consumer's purchase. In another embodiment, the first and second commissions may be a cost of the consumer's purchase, such as two percent.

In a further embodiment based on FIG. 9, the introducer is associated with the first consumer by providing a second identification information by the first consumer useful to identify the introducer, thereby associating the introducer with the first consumer. In another embodiment, the introducer is associated with the first consumer by communicating a second purchase recommendation from the introducer to the first consumer, making a second purchase by the first consumer based on the second purchase recommendation, providing a second identification information by the first consumer useful to identify the introducer, determining a third reward to provide to the introducer based on the second purchase, and furnishing the third reward to the introducer.

In another embodiment of FIG. 9, the first and second rewards are furnished only if each exceeds a certain predetermined threshold, such as twenty-five British pounds. Additionally, the method of FIG. 9 may provide automatic email notification to the introducer and the first consumer notifying them that the second consumer has joined and named the first consumer as the second consumer's introducer, that the second consumer made a purchase, and that a first and second reward has been determined.

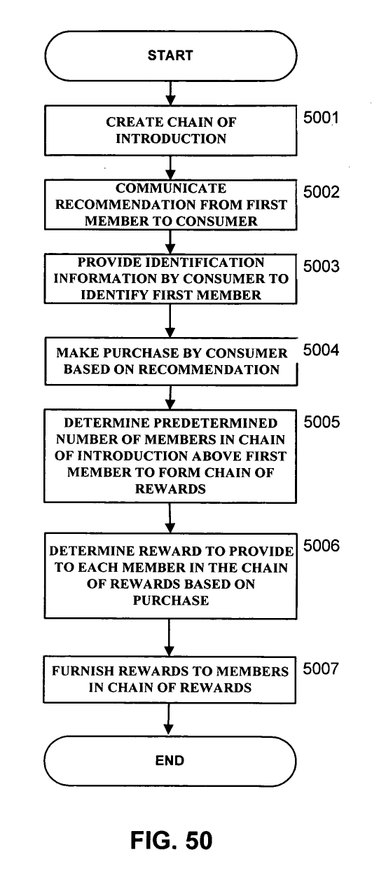

Another embodiment of the present invention useful for network marketing is illustrated in the embodiment of FIG. 50. First in the embodiment of FIG. 50, a chain of introduction is created consisting of a plurality of members, with each member in the chain of introduction associated with another member who is above them in the chain of introduction by being that member's respective introducer 5001.

Second, a recommendation is communicated from a first member to a consumer, where the first member is part of the chain of introduction 5002. Next, identification information is provided by the consumer to identify the first member 5003.

Fourth in the embodiment of FIG. 50, a purchase is made by the consumer based on the recommendation 5004. A predetermined number of members in the chain of introduction above the first member is determined to form a chain of rewards, with the chain of rewards being a proper subset of the chain on introduction 5005. Sixth, a reward is determined to provide to each member in the chain of rewards, based on the purchase 5006. Finally, the determined reward(s) are furnished to the members in the chain of rewards 5007.

The embodiments and methods described above illustrate the no-fee Internet marketing system of the present invention which rewards participants for making referrals that result in actual sales by paying commission on the sale. The present invention thus provides the opportunity for members to generate substantial revenue with no initial cost. One skilled in the art will appreciate that the present invention described above can be implemented more specifically tailored to meet the industry constraints associated with a given application. This tailoring is most clearly seen with the illustrative example described below.

### Travel Industry Application

While the network marking method of the present invention can be used in a variety of applications, one possible application is with a travel-based business, such as a travel club. For example, OctopusTravelCLUB is an Internet-enabled network-marketing scheme which illustrates several aspects of the present invention and which thereby enables members of OctopusTravelCLUB to earn commissions on sales by doing no more than forwarding an email or telling a friend that promotes a product offered by OctopusTravel.com. The aspects and embodiments discussed with respect to octopustravel.com are for illustrative purposes only and in no way limit or define the scope of the invention.

A number of commission structures are possible in the various embodiments of the present invention. In the current embodiment directed towards a travel club, a 2% commission is paid to an OctopusTravelCLUB member for bookings made by a person (s)he introduced to OctopusTravel Club and a further 2% to the chain of introducers, up to five levels back from the purchaser. Thus, a maximum of 10% commission is paid to the people who have communicated purchase recommendations on the behalf of OctopusTravel. While a 2% commission is used for illustration, the present invention may be used with other commission rates such as 3%, 1%, 6%, 4%, or some other percent. Moreover, the number of levels corresponding to a chain of introducers can be 1, 2, 3, 4, 6, or any other number.

### Commission Model Illustration

For illustrative purposes, the commission model of the current embodiment is shown at each of the five levels, with a 2% commission rewarded at each level. Once registered as a member, the member receives 2% commission on every booking made within his or her ‘network’, where the ‘network’ comprises all the people who receive an email within five levels of the member. In the present embodiment, each level assumes that the members who register enter their true introducer.

First Level

If a member emails 10 people to tell them about OctopusTravel Club and one of them subsequently joins OctopusTravel Club and makes a booking, the member receives a 2% commission on that booking.

Second Level

If those 10 ‘first level’ people each register with OctopusTravel Club and pass on the email or tell to another 10 people (so the message reaches 100 more people) in the same proportion of 1 in 10, and make a booking, the member receives a 2% commission on each of those 10 bookings.

Third Level

If those 100 ‘second level’ people each register with OctopusTravel Club and pass on the email or tell to yet another 10 people (so the message reaches 1,000 more people) in the same proportion again, the member receives a 2% commission on each of those 100 bookings.

Fourth Level

If those 1,000 ‘third level’ people each register with OctopusTravel Club and pass on the email or tell to yet another 10 people (so the message reaches 10,000 more people) in the same proportion, a 2% commission is received by the member on each of those 1,000 bookings.

Fifth Level

Finally, if the 10,000 ‘fourth level’ people each register with OctopusTravel Club and pass on the email or tell to yet another 10 people (so the message reaches 100,000 more people) in the same proportion again, the member receives a 2% commission on each of those 10,000 bookings as well.

In the example above, if every booking were worth £200, the introducing member would earn £44,444 (£4 for the one first level booking, £40 for the ten second level bookings, £400 for the 100 third level bookings, £4,000 for the 1,000 fourth level bookings and £40,000 for the 10,000 fifth level bookings). Thus, the present invention can enable a member to earn substantial amounts of real money for free by doing nothing more than recommending goods or services.

### Web Interface

Octopstravelclub.com illustrates several aspects of the present invention and provides the user with the ability to participate in one embodiment of a network marketing system as described in the present application. A user navigates and interacts with various web pages associated with octopustravel.com in order to participate in the disclosed marketing system. Therefore, several of the web pages are described below in order to enable one of skill in art to readily make and use the marketing system of the present invention.

The Home Page of octopustravelclub.com illustrates an International Home Page for use by all geographic markets in one embodiment of the present invention. The user can select their country of residence and will be redirected to the appropriate Regional Home Page. A cookie can be used to remember the country of residence. If the cookie is available, then the user can be routed to the Regional Home Page. There may be 2 links on this page which will show the defaulted country of residence with a link to ‘Click here if not correct’ that will take the User back to the International Home Page to re-select the correct country. The links may be in the ‘Join Now’ box and also in the main part of the Page, which will be giving information about the CLUB. When a member logs in from the Home Page, they will be directed to the correct regional site of OctopusTravelCLUB based upon their country of residence in their registration. Hence, languages, currencies, and local office support will be localised for each member. Localisation for various nationalities is provided by various mean, including Unicode text, localized currency, and localized date formats.

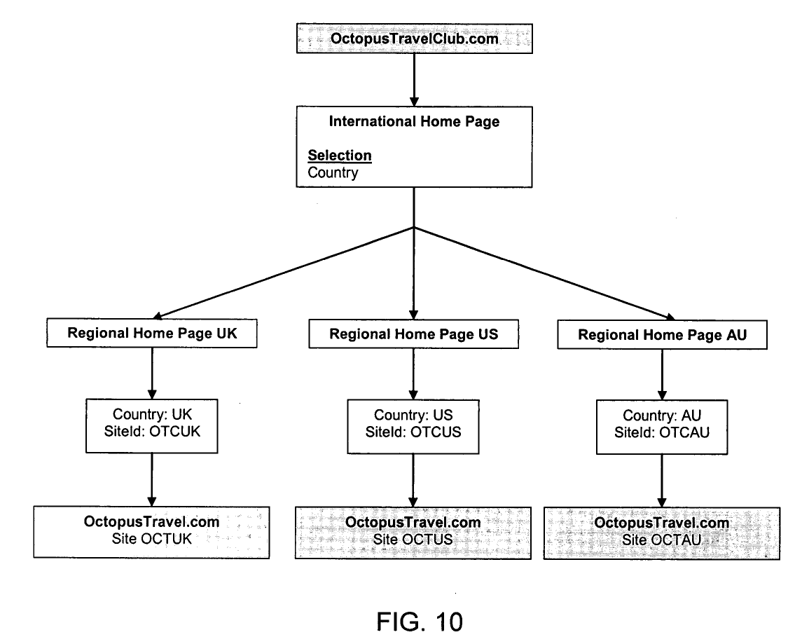

Regional Travel Club sites may be part of an existing site in various embodiments. For example, OctopusTravelCLUB UK will be part of OctopusTravel UK (OCTUK). This will ensure that specific site characteristics will apply to the CLUB site. FIG. 10 illustrates one embodiment of the basic website structure useable by OctoputTravelClub.com.

### International Home Page

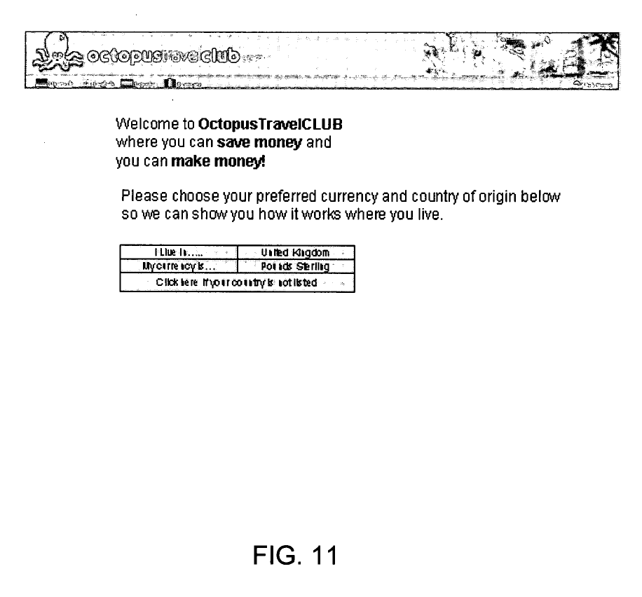

FIG. 11 illustrates the International Home Page of the octopustravelclub.com website. The International Home Page allows a consumer to enter their place of residence. The resulting selection will then go to the appropriate Regional Home page.

### Regional Home Page

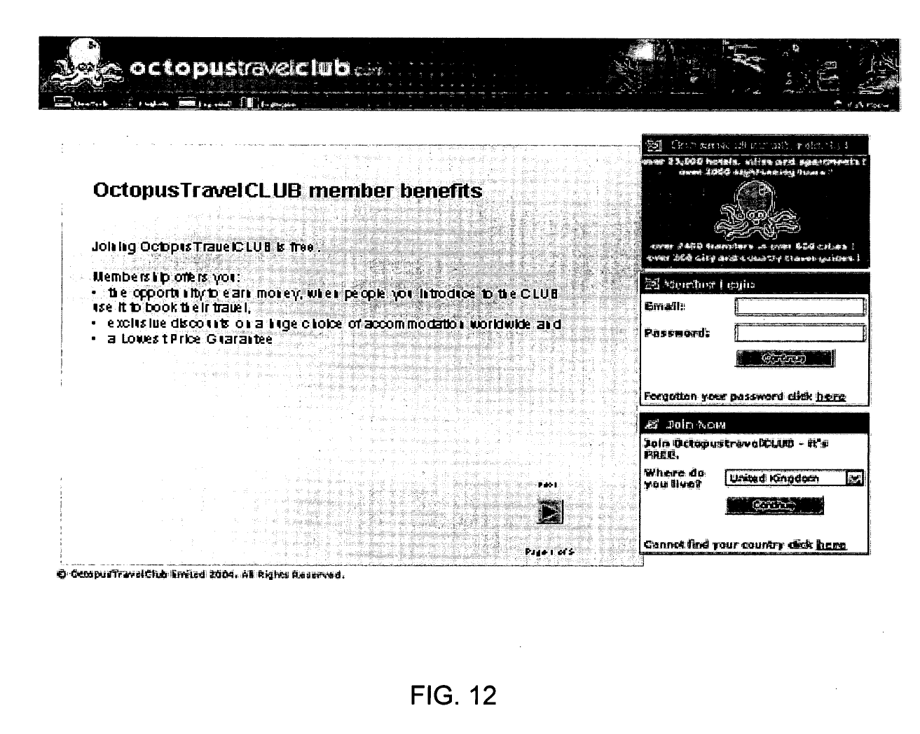

The Regional Home Page as illustrated in FIG. 12 allows the consumer to register, login, and learn more about the club. In one embodiment, the link in the main part of the page activates a Flash presentation explaining how the CLUB operates. Additionally, the footer of the Regional Home Page may contain links to four static documents entitled: About Us, Club Rules, FAQ and Contact Us.

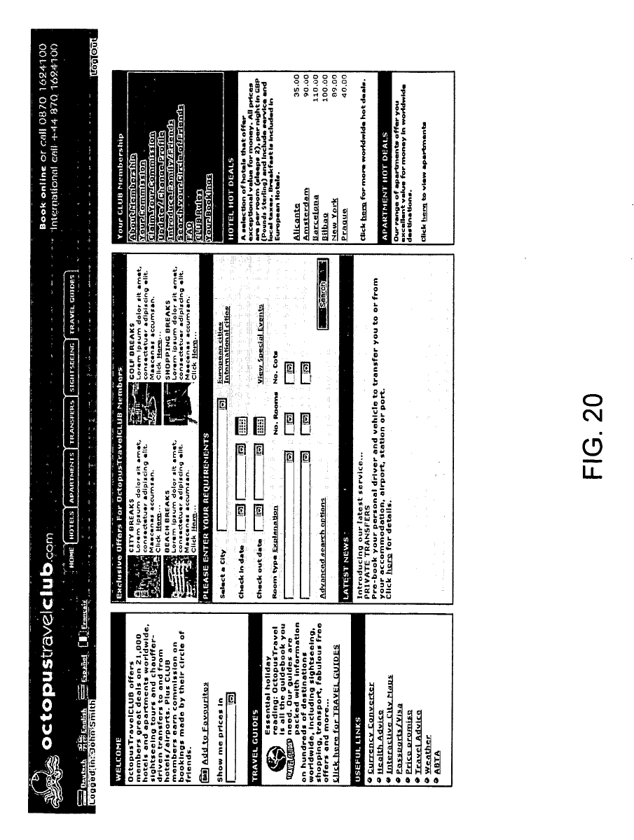

To validate the user's login, both the ‘Email’ and ‘Password’ fields must be entered. The ‘Member Log In ’ Continue button will validate the log in details. If they are incorrect, then a red text description will state that the information provided was incorrect, e.g. ‘Your attempt to login was unsuccessful. Please try again.’ and ‘Attempts remaining: 3’. The maximum attempts may be set to 5. If the details are correct, then the page will redirect to the appropriate Local Home Page as illustrated in FIG. 20. After the final attempt of entering a password, the password entry box will disappear and a message will be displayed indicating that the user needs to enter their email so their password will be emailed to them. While five attempts are shown by way of illustration, the login attempts could be 1, 2, 4, or any other number.

If the email address input by the user is not recognised as a club member, then an email explaining this will be sent. If the email address is recognised, then normal password email will be sent.

Various hypertext links may be included on the Regional Home Page and on other pages as well. The ‘Club Home’ link can be provided which directs the user back to the international home page. A ‘Tell Me More’ link may be provided which directs the user to the ‘More About the Club’ page. A ‘Join Now’ Continue button may be provided to go to the Registration Details page. A ‘Member Log In ’ Continue button may be provided. Also, a ‘Forgotten Password’ may open a pop-up window stating that the password has been emailed to the member. Also, a Forgot Password Email link may be provided.

### More about the Club Page

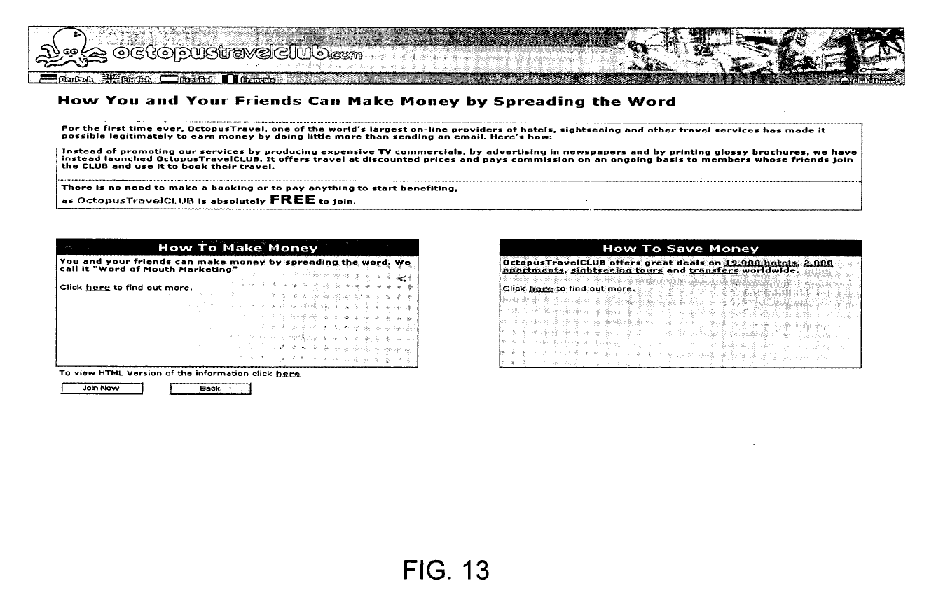

The benefits of membership and overview of the workings of the CLUB may be described in the More about the Club Page, as shown in the screen capture of FIG. 13. For example, in a Flash presentation can be used to inform a user about the network marketing program of the present invention. At the end of the presentation, there can be links to FAQ, Join, Preview the CLUB site, and Rules web pages. This page can be a static HTML and define the concept of OctopusTravel Club.

More about the Club Page Links:

Hotels, Apartments, Sightseeing and Transfer links can load the appropriate tab on the local home page, e.g. the Hotels link will open the ‘Hotels’ tab on the home page.
‘Join Now’ will direct to the registration process at the Registration Page.
‘FAQ’ may direct to the FAQ Page.
The footer can contain the following links: ‘Back’, ‘Next’ and ‘Join the Club’.

### FAQ Page

A Frequently Asked Questions (FAQ) Page can be used with one embodiment of the octopustravelclub.com web site, and is illustrated in FIG. 14. This page can be a static HTML page listing all the frequently asked questions.

### Registration Page

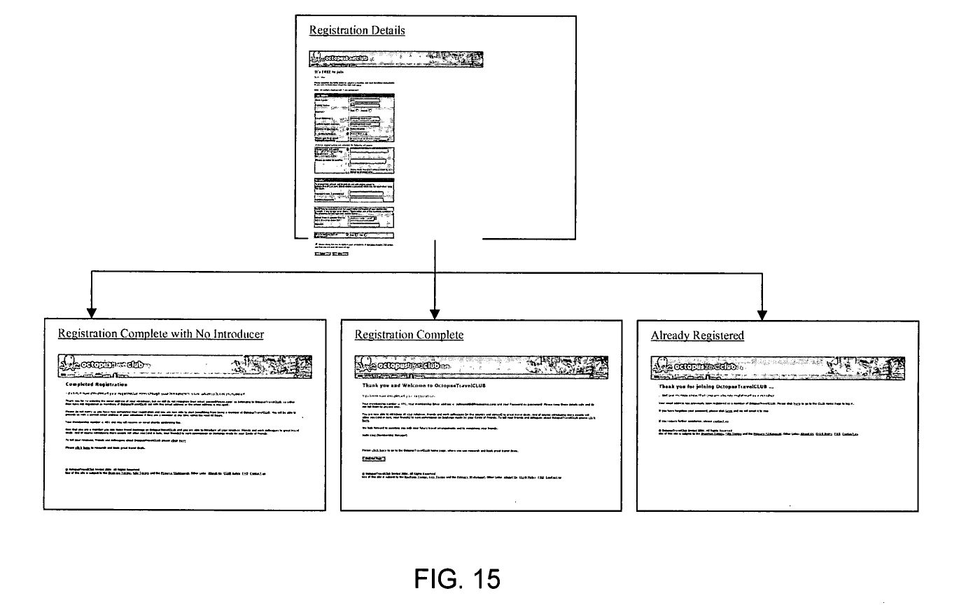

The diagram of FIG. 15 shows an overview of the Registration Pages and their relationships as used in one embodiment of the octopustravelclub.com website.

### Registration Details Page

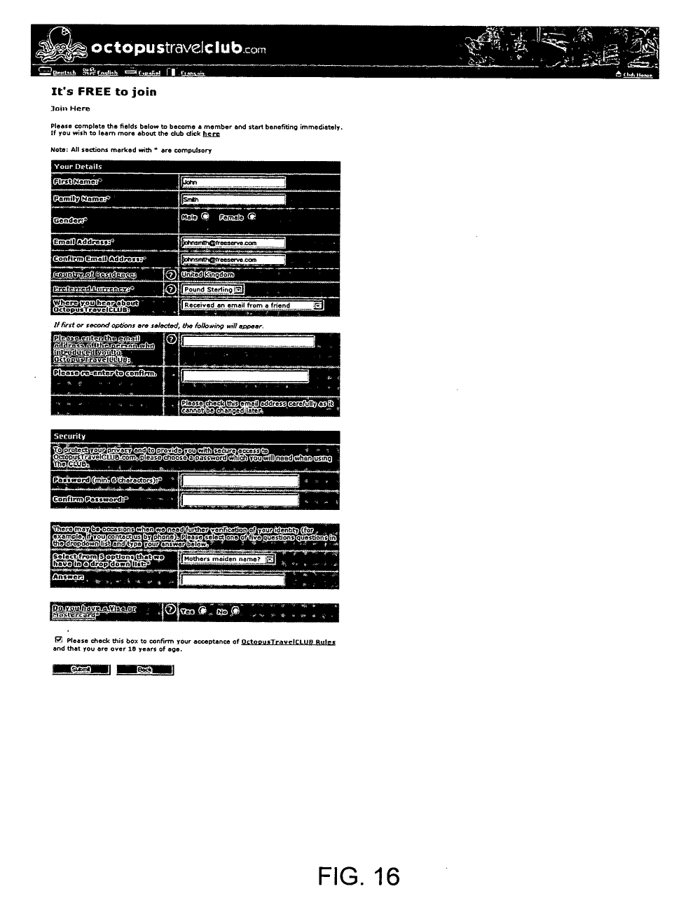

FIG. 16 shows a screen capture of the Registration Details Page of octopustravelclub.com. This page provides all of the information used to register a new account, and may provide one or more of the following functionalities:
‘Preferred Currency’ dropdown may be built by selecting a currency list based on the country of residence. If there is only one possible currency then this will display as text only and not a dropdown list, for example the US site will display US Dollars.
An introducer/member id may be passed to this page from an email with a deep-link to this page.
‘Where did you hear’ dropdown may contain options, some of which will use additional input via the Introducer Email box.
‘Security Question’ dropdown may have a new Control Value that will hold the appropriate selections.
   The Registration Details Page may validate information in a variety of ways, such as:
If any information is invalid then an Alert box can display an appropriate message.
‘Email Address’ and ‘Verify Email Address’ should match.
‘Introducer Email Address’ and ‘Verify Introducer Email Address’ should match.
The Introducer email address should not be the same as the member's email.
If the introducer email is not valid (validated against current member database) then this page will reload displaying an appropriate message. However, if the user enters an invalid email twice then the registration will complete regardless. While two may be used, any other suitable such as three, four, or six can be used with the present invention.
The ‘Password’ and ‘Confirm Password’ should match.
If ‘Do you have a Visa/MasterCard?’ checkbox is not checked, then display the following message ‘You will need a Visa/MasterCard to collect your commission’ or a bank account if you live in the U.S. The user may still be allowed to register.
The ‘Terms & Conditions’ checkbox must be selected for the registration to continue.
   Registration Details Page Links:
‘Octopus Travel Club Rules’ link will open a static page of the terms and conditions.
‘Submit’ button will go to the relevant page depending on the validation. Registration Complete Page

### Registration Complete Page

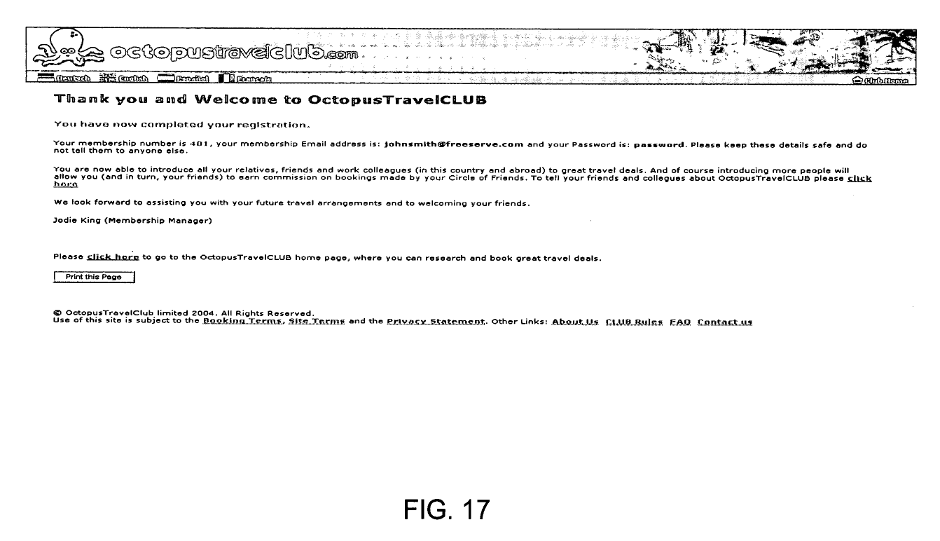

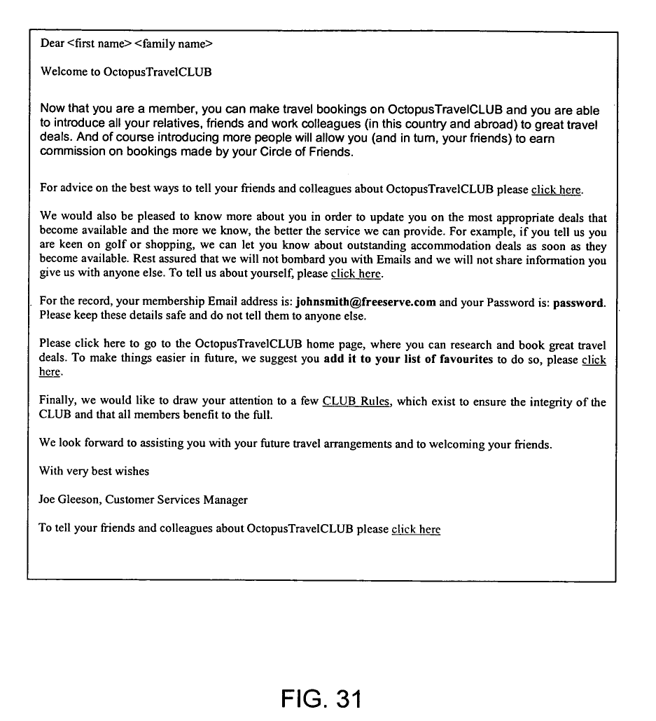

The Registration Complete Page is a static HTML page and is displayed once registration has been completed successfully, and is shown in the screen capture of FIG. 17. Once the registration process is complete, the new member may be added to a global database. Additionally, an email may be sent to the new participant confirmation registration. For example, the Registration Confirmation Email of FIG. 31 may be sent.

Registration Complete Page Links:

The links that enable the user to enter a “member's area” are available after log in. The system will automatically log in the member when redirected to the appropriate ‘local’ site. The links that use this process are:
   ‘Tell Friends and Family’
For security, this feature will normally be available after the registration process and will not be available through email links.
‘Home Page’ link—Local Home page, log the user in automatically.

### Registration Complete with No Introducer Page

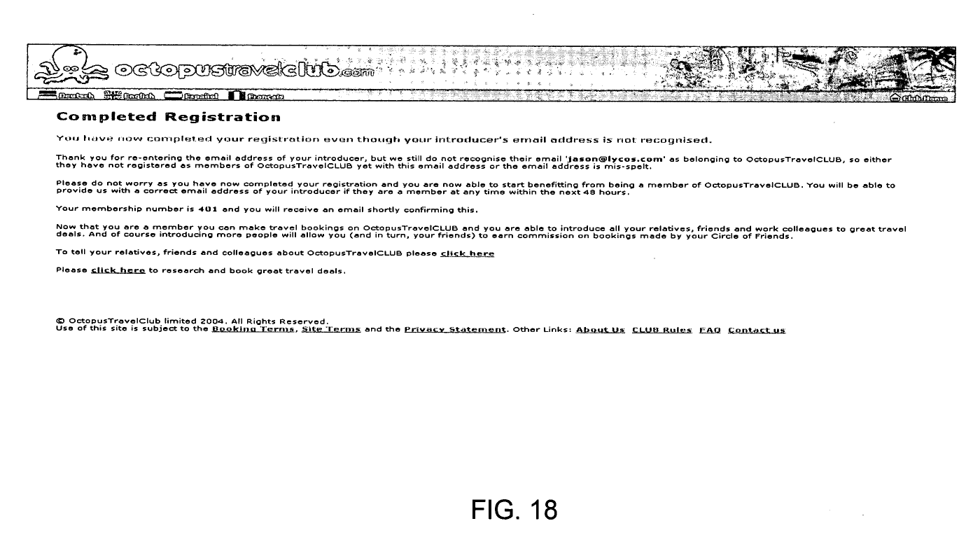

The Registration Complete with No Introducer Page is shown in the screen capture of FIG. 18 and is a static HTML page and is displayed if an introducer's email address has not been successfully verified at the No Introducer Page. A Control Value may be created for a time restriction to enter an introducer (e.g. 12, 24, 48, 72 or some other suitable number of hours). Also, an email will be sent to the member confirming registration, for example, the Registration Confirmation Email (No Introducer) email may be sent. The links provided for the registration complete page may be used for registration complete with no introducer page.

### Already Registered Page

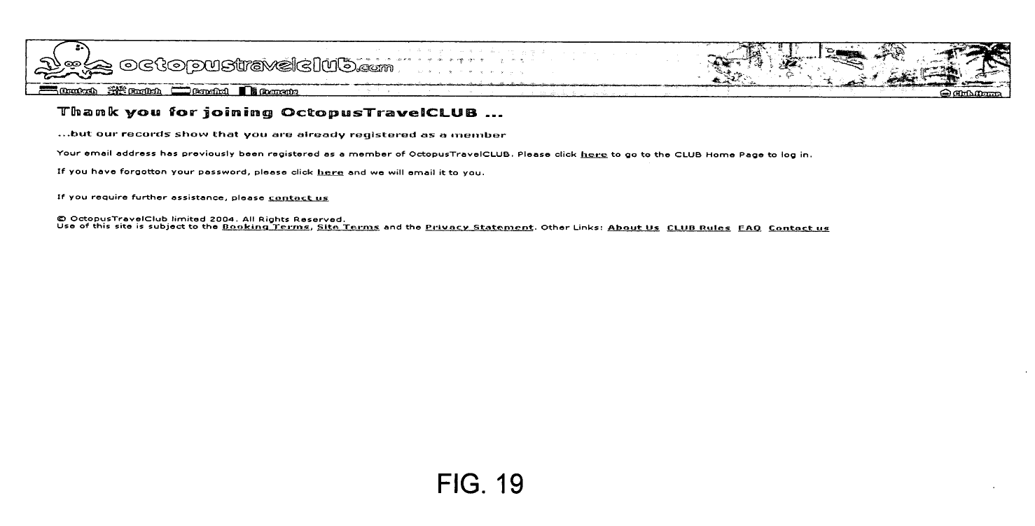

The Already Registered Page is a static HTML page which is displayed if the email entered has already been registered. A screen capture of the Already Registered Page is shown in FIG. 19.

Already Registered Page Links:

The link to the home page will go back to the Regional Home Page.
The ‘Forgotten Password’ link opens a pop-up window specifying that an email has been sent with the login information.
   See Forgot Password Email for more information.
The ‘Contact Us’ link displays the following static HTML page:

### CLUB Rules (Pop-Up)

The CLUB Rule pop-up window is a static HTML page listing all the club rules.

### Local Home Page

The Local Home Page allows members to log in and is shown in the screen capture of FIG. 20. Non-members may browse the site, including any searches, but they may not be able to make any bookings. If a non-member tries to make a booking, then the login page will be displayed.

Local Home Page Functionalities:

If a member has logged in then the ‘Show me prices in’ dropdown will default to their preferred currency. This is defined in the Registration Details Page.
Once logged in the member's name will appear on the left side of the title/header bar.
The ‘Exclusive Offers’ box will be included on this page, and is described in the Exclusive Offers Page.
   Local Home Page Links:
The ‘Log In’ link as described in the Login Page links to the Login Page.
The ‘Log Out’ link references the Logout Page.

### Login Page

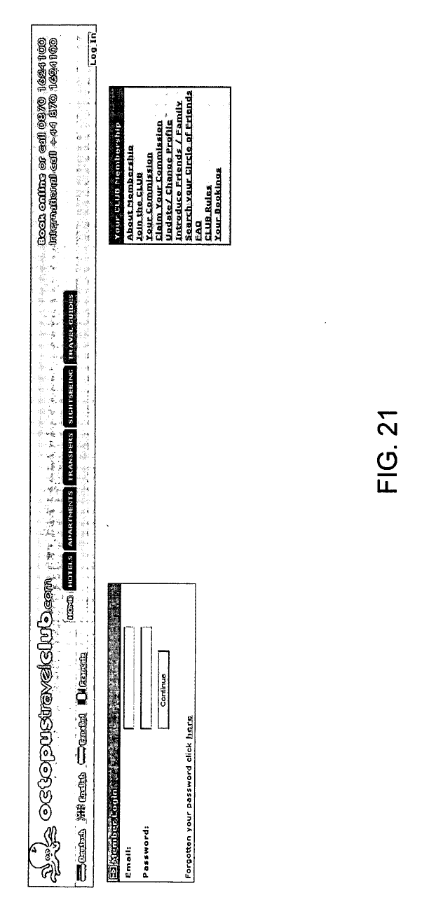

The Login Page is shown in the screen capture of FIG. 21. The Login Page is secure, and allows users to input sensitive information.

### Logout Page

This page contains two Unicode entries to accommodate a goodbye message. The user remains on the local home page site. This message may be within a pop-up box. To display for a number of seconds and contain a ‘Close’ link and will appear on the Local Home Page. Upon closing, the Local Home Page may appear. In addition, the Logout Page pop-up box could have a timer that displays for a pre-selected amount of time before automatically closing. Upon closing, the Local Home Page appears.

### Exclusive Offers Page

The Exclusive Offers Page is a static HTML page associated with the octopustravelclub.com website, and presents exclusive offers to members.

### Your CLUB Membership Links

The ‘Your CLUB Membership’ links will change depending on whether a user is logged on or not.

For all users the links available are as follows:
About Membership—See More About the Club Page.
Your Commission—See My Commission Page.
Claim Your Commission—See Claim My Commission Page.
Update/Change Profile—See Update/Change My Profile.
Introduce Family/Friends—See Introduce Family or Friends.
Search Your Circle of Friends—See Network Search Page.
FAQ—See FAQ Page.
CLUB Rules—See CLUB Rules Page.
Registration—See Registration Details Page.
Your Bookings—See Your Bookings Page.

For non members the following links will be static HTML pages:
Your Commission.
Claim Your Commission.
Update/Change Profile.
Introduce Family/Friends.
Search Your Circle of Friends.
Your Bookings.

### My Commission Page

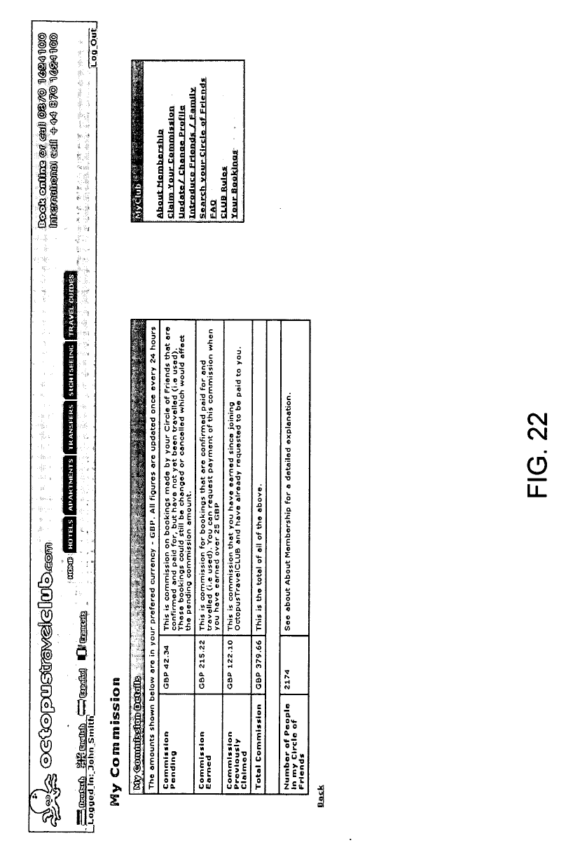

The My Commission Page is shown in the screen capture of FIG. 22, and displays relevant commission information for the member.

My Commission Page Functionalities:

The minimum amount that can be claimed will be retrieved using a Control Value.
All information will be available from the global database.

### Claim My Commission Page

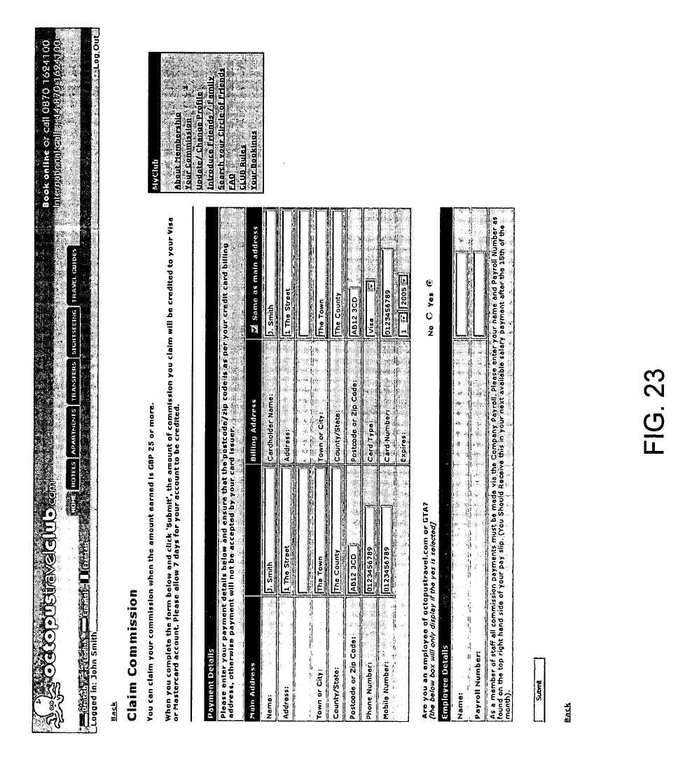

The Claim My Commission Page(s) allow the member to claim commission earned. One Claim My Commission Page is shown in the screen capture of FIG. 23. The details listed below apply to all variations of the claim my commission page, as different information is used for each payment method.

Claim My Commission Page Functionalities:

This page opens as a pop-up window so the whole page may be secure, as it will allow input of sensitive information.
The amount of commission being claimed will be of the entire amount available.
If the ‘Are you an employee?’ checkbox is checked then the following information will be display and will be used for input:
   Name
   Payroll Number
   Company dropdown list (Octopus or GTA)
   Office dropdown list (A new file will be used for this list)
The minimum commission amount will be a setup using a Control Value.
   Claim My Commission Page Validation:
The ‘Amount of Commission being claimed’ must be greater than the ‘Minimum commission amount’.
If the ‘Are you an employee?’ checkbox is checked then the following information will be display and will be used for input:
   Name
   Payroll Number
   Company dropdown list (Octopus or GTA)
   Office dropdown list (A new file will be used for this list)
      Claim My Commission Automated Clearing House (ACH) Payments

The US website may use ACH as the method of payment with the following information.

ACH Payments Information:

Bank Name
Account Type dropdown (Checking or Savings)
Routing Number (9 digits)
Account Number (3-17 digits)
   ACH Payments Validation:
All ACH Information must be entered.
   ACH Payments Links:
‘Submit’ button will action the appropriate payment process.

### Update/Change My Profile Page

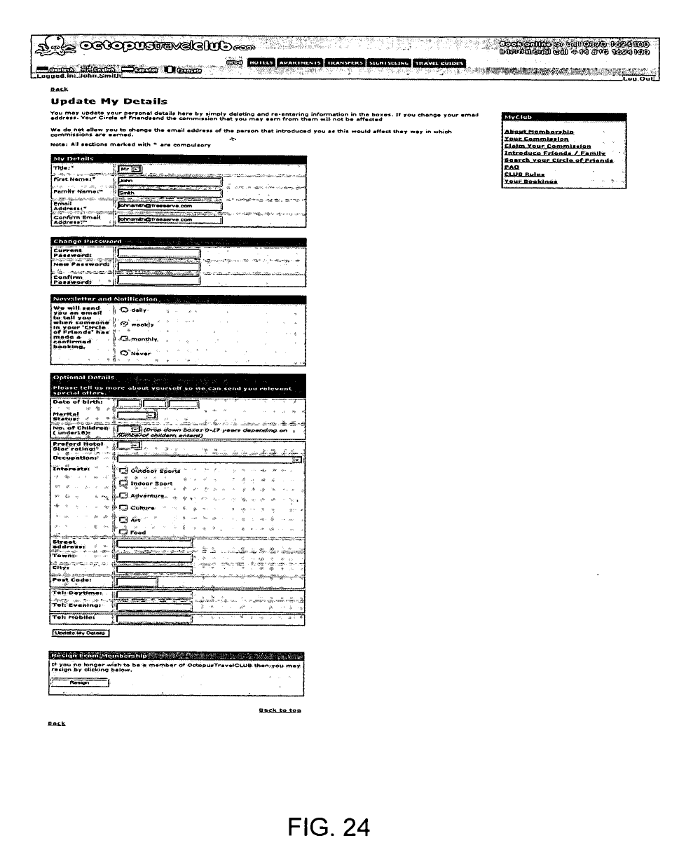

The Update/Change My Profile Page is shown in the screen capture of FIG. 24. This page allows the member to change any of their personal details.

Update/Change My Profile Page Information:

All of the dropdown boxes will be maintained using control values. The exception to this rule will be the numeric lists, e.g. Number of Children and Star Rating.
For the ‘interests’ field this should be specifiable at regional site level and include up to 20 options.
Occupation list choice also to be determined by site
   Update/Change My Profile Page Validation:
‘Email Address’ and ‘Verify Email Address’ should match.
   Update/Change My Profile Page Links:
The ‘Update’ button will update the member's details.
The ‘Resign’ button will take user to the Resign Confirmation window.

### Resign Page

The Resign Page allows a member to terminate their membership, causing any unclaimed commission to be forfeited. All future commissions are also forfeited.

Resign Page Links:

The ‘Resign’ button will open a confirmation box. If the member agrees to resign then the following will take place:
   Set the member to resigned.
   The member will automatically be logged off.
   The Resign Confirmation Email will be sent.

### Introduce Family or Friends Page

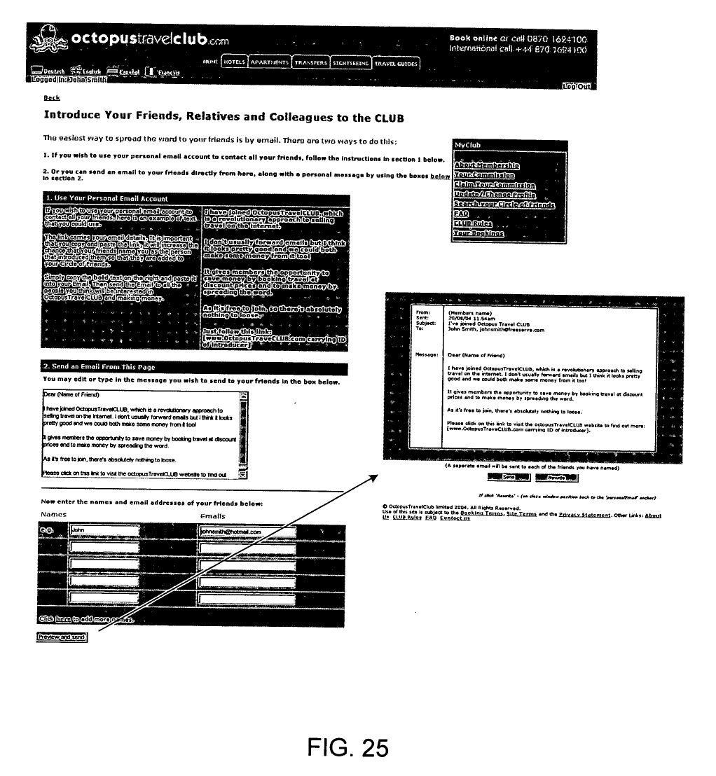

The Introduce Family or Friends Page is illustrated in the screen capture of FIG. 25.

Introduce Family or Friends Page Information:

The email text will include a link to OctopusTravel Club that includes the current member's id.
A count of the number of emails sent and when will be logged against the member.
   Introduce Family or Friends Page Validation:
The emails entered should all be different.
   Introduce Family or Friends Page Links:
‘Use your own email’ link will position the page at ‘Use Your Personal Email Account’.
‘Add more names’ link will add an additional Name and Email box after the existing ones.
‘Preview and send’ button will open a pop-up window; see window above.
   The ‘Rewrite Message’ link will close the window.
   The ‘Send Message’ link will send the emails to the relevant addresses.

### Network Search Page

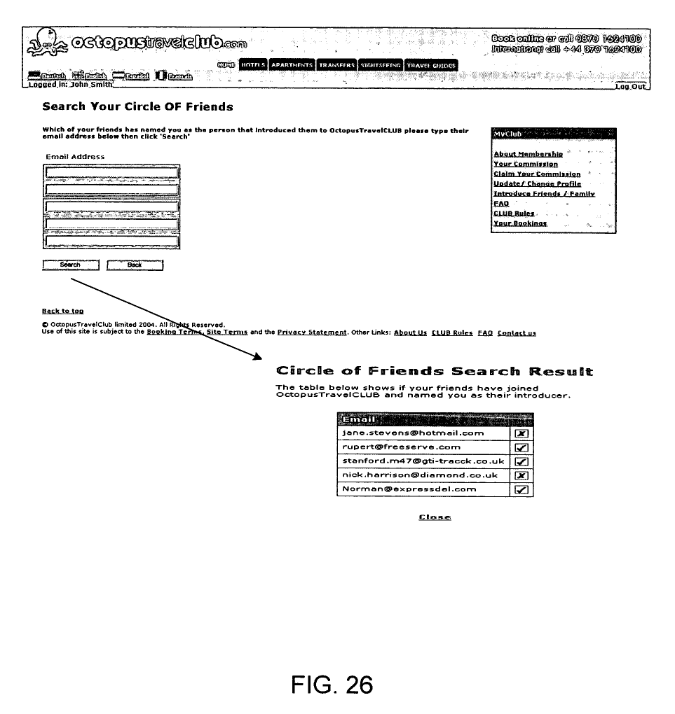

The Network Search Page enables members to see whether an individual is part of their network, and is shown in the screen capture of FIG. 26.

Network Search Page Information:

This page will display a list of Email boxes that will allow the member to check whether specific people are part of their network. In an alternative implementation, this search could be for two, three, five or some other suitable number of levels below.
   Network Search Page Links:
The ‘Submit’ button will open a pop-up window displaying the results.
   Those that who have joined and named the member as their introducer will display a tick.
   Those that who have joined and not named the member as their introducer will display a cross.
   Those that who have not joined will display a cross.

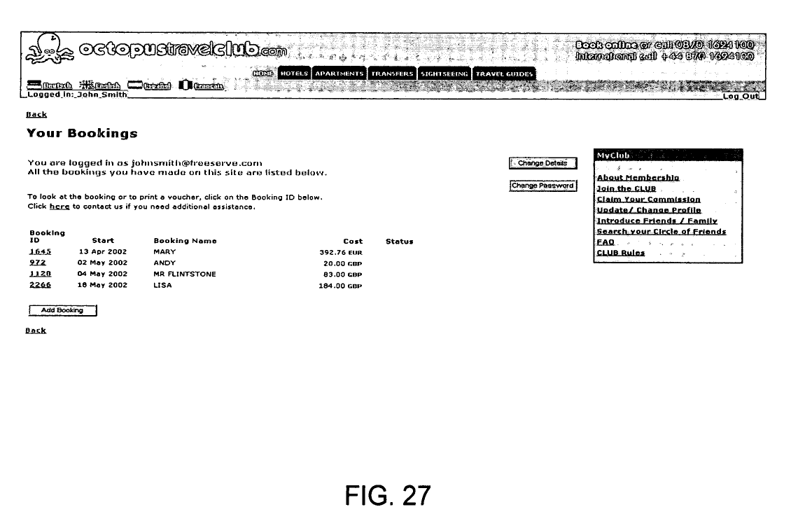

### Your Bookings Page

Where the present invention is used with an existing e-commerce site that has page(s) showing transaction or account history (Your Account for OctopusTravel), the My Club membership box may be shown on the same page. The Your Bookings Page is shown in the screen capture of FIG. 27.

### Calculating Commission

In the embodiment of the present invention represented by octopustravelclub.com, the purchase commission may be calculated in various ways. For example, all purchases may generate the same commission amount, or specific commission amounts may be applied to different bookings if desired (e.g. 2% Hotels, 1% Sightseeing, 0% All Other Items). The ‘Work with Item Type Commission’ will be used to maintain these values. The commission on the booking will represent one member's payment.
Any web pages that display the commission amount may be changed to provide a link to Member Commission Links Page. This will generally apply for Travel Club bookings.

### Calculating Commission Pending

When a booking becomes confirmed and fully paid the commission amount will be added to the relevant introducer's ‘Commission Pending Amount’. If a booking/item is cancelled, then the original booking/item commission amount will be deducted from the introducer(s) commission pending amount. If there is any commission left on the booking because only part of the booking was cancelled, then the remaining commission amount will be added to the introducer(s) commission pending amount.

### Calculating Commission Earned

Commission is applied to any introducer(s) eligible to be claimed once a booking has been consumed. A booking is considered consumed on the last items return date (departure date plus duration).

It is possible that a booking may be changed or amended after the last items consumed date. This means that the pending commission amount should not be recalculated, as the amendment may be related to quality/complaint issues so any amendments after the last item consumed date must not affect pending commission.

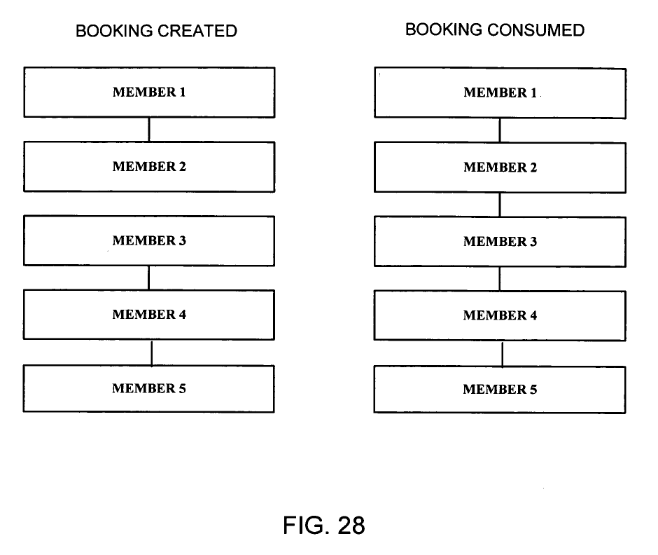

The diagram of FIG. 28 illustrates which introducers will be selected. For example, member 5 creates a booking. At the time the booking was made there was no link between member 2 and member 3. Before the booking is ‘consumed’ the link between 2 and 3 has been made. Member 1 and 2 will also receive commission.

A ‘snap-shot’ of all the introducers eligible for commission will be associated against a booking, and will be used to assist with the answering of any member enquiries. The conversion to the introducer's preferred currency may use the exchange rate when the item was created and the same safety as per pricing routines.

### Commission Payments

Several types of payment methods may be available on octopustravelclub.com, including credit card and ACH payments.

### Credit Card Payments

All Credit Card transactions may be made through London SOLVE. If SOLVE authorise the credit card, then the members commission claim is set to ‘Commission Paid’. If authorisation fails, then the member's claim is set to ‘Payment Failed’ and the user will receive a message advising them to recheck their card details and try again.

### ACH Payments

A new report, which may be contained in a CSV file, will produce a list of outstanding claims made using ACH. The selection page will allow input of a Travel Club Region (e.g. ‘All’ or ‘US’) and a date range; the report will select the appropriate claims that are in a status ‘Not Paid’. Once a member commission claim has been selected by the report, then each commission claim will be changed to ‘Commission Paid’.

The report may contain the following information:
Client First Name
Client Surname
Address Details
Currency
Amount
Country
Bank Name
Account Type (Checking or Saving)
Routing Number
Account Number

When the report has been generated, then the details for each commission payment are sent to OctopusTravel's accounts systems.

### Staff Payments

A report may be run through the Call Centre, which will identify staff payments for a given month. The selection screen provides the following information:
Company (Octopus or GTA) or ‘All’
Office (These options will be maintained using a new file)

Once a member commission claim has been selected by the report, each commission claim will be changed to ‘Commission Paid’.

### Successful Payments

For each successful payment transaction the following will take place:
Booking payment transactions will be created against the bookings that make up the total commission claimed amount. A new transaction type will be used and this will be called ‘Member Commission’ (MC). This transaction will not have any impact on the booking amounts and will be for informative purposes only.
OctopusTravel's accounting systems will be updated.

### Accounts

The commission payments are allocated to the appropriate booking transactions as a new transaction type of Member Commission (MC). The transactions are created when a member claims their commission.

Once a payment has been initiated by an OctopusTravelCLUB member using either CFT or ACH, the details are forwarded to the interface which is input to OctopusTravel's accounting systems.

Payments to OTC members normally represent commission for more than one booking. The Existing Payments Interface can be used with the addition of a new file to pass through the booking details and payment breakdown for a commission payment. The data elements identified by GTA Accounts department to be passed through are as follows:—

CFT Transactions
a) Currency (GTA)
b) Amount
c) Payment Date
d) Club Member ID
e) Site Number
f) Client ID (By this we mean OCTUK for example)
g) Card Number
h) Card Type
i) Credit Card Authorisation Number
j) Card Expiry Date
k) Card Name

If a CFT transaction is not authorised, no details are passed to the accounting systems.

### ACH Transactions

The ACH scheme may be used in the US. Once commissions have been reported to OctopusTravel's New York office, the website may treat them as Commission paid. The following data can be recorded in the OctopusTravel accounting systems. The download files may be populated after every successful report generation.
a) Currency (GTA)
b) Amount
c) Payment Date
d) Club Member ID
e) Site Number
f) Client ID (By this we mean OCTUK for example)
g) Payment Run sequence number

### Payments Header Files

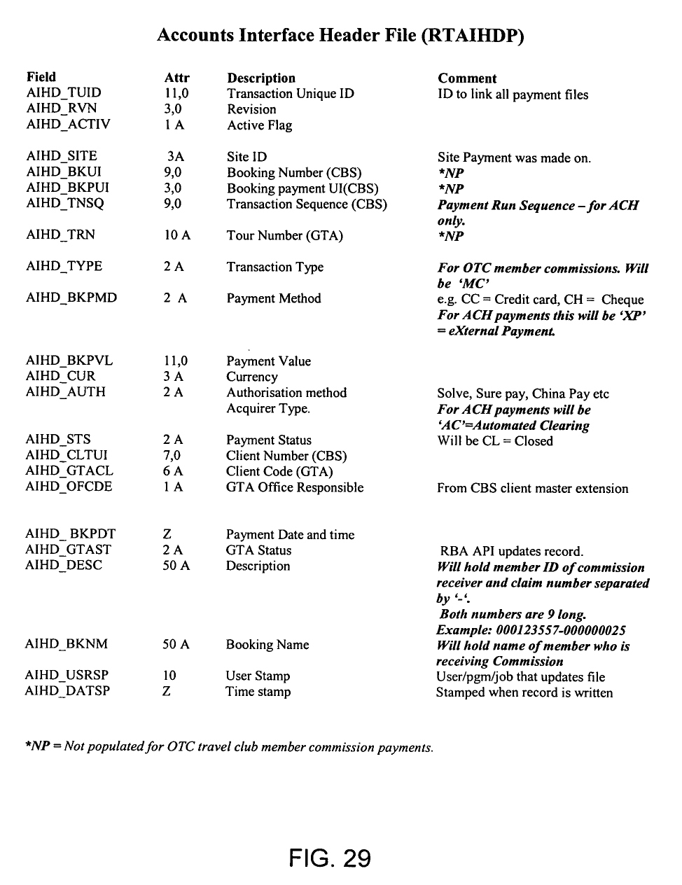

The existing Interface Header file for payments (RTAIHDP) will hold details relevant to the total amount paid for each claim. The Accounts Interface Header File (RTAIHDP) is shown in FIG. 29. There may be no records written to Header Extension file (RTAIHXP).

### Payment Details

Payment detail files will hold the details of the actual payment. For credit cards this is RTAICCP and for cheques, cash and bank transfers this is RTAINCP.

### Commission Payment Breakdown

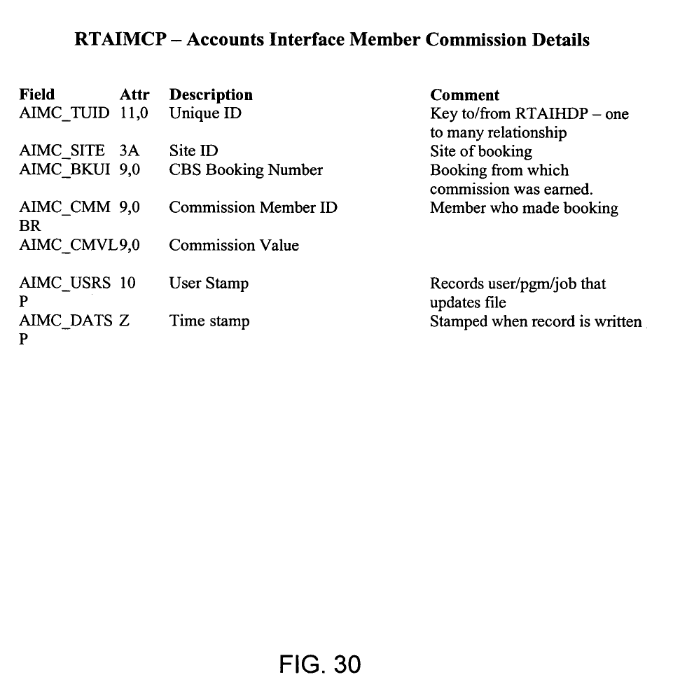

A separate file will hold the composite parts of a commission payment claim. The total value of these records equals the total commission. The commission payment file is illustrated in FIG. 30.

The data used for the commission payment claims is as follows:
Site ID (Site where booking was made as this could be different to site where commission payment is being paid)
Member ID (member who made booking)
Booking Number
Payment Value (Value will always be in currency of Header payment)

All other details relating to the booking will already exist in OctopusTravel's accounting systems from the appropriate payment downloads for the actual booking itself.

### Emails

OctopusTravel may send out emails in a variety of formats, including plain text, HTML, and XML. In one embodiment, all emails may be generated as text instead of HTML to ensure the widest possible compatibility.

Some emails may be processed at different time intervals, such as daily, weekly, or monthly. Any emails that are not processed immediately will need information to be stored for processing at a later stage. These emails will be consolidated and executed at the end of the given time period. An ‘Email Reference’ file will be created to hold any relevant information for the production of the emails.

The emails detailed below are categorised depending on how they will be processed. Email categorization is broken down by the following:
The ‘Email Type’ specifies how the email may be generated. Emails can either be produced via the web or from the AS400.
The ‘Run Type’ indicates whether the email is processed ‘Immediately’ or in ‘Batch’. An immediate email will gather the information it uses and is sent at runtime. A batch email will run at a specified time period, e.g. (Daily/Weekly/Monthly).

### Registration Confirmation Email

The Registration Confirmation Email is illustrated in FIG. 31 and has an email type of Web, and a Run Type of Immediate.

### Registration Confirmation Email (No Introducer)

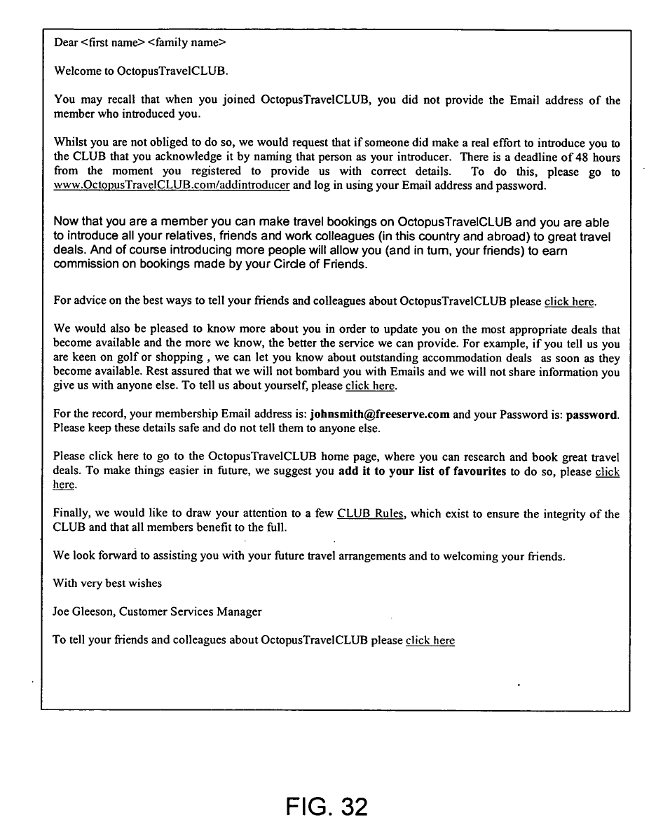

The Registration Confirmation Email (No Introducer) is illustrated in FIG. 32, has an email type of Web, and a Run Type of Immediate.

### No Introducer Reminder Email

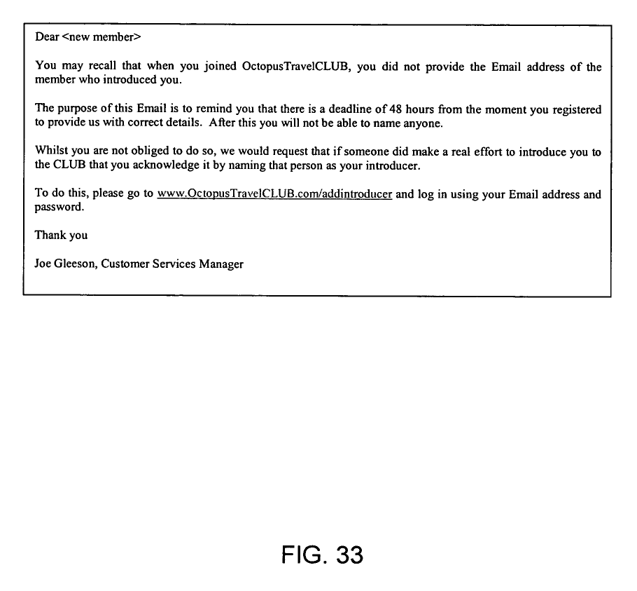

The No Introducer Reminder Email is illustrated in FIG. 33, has an email type of Web, and a Run Type of Immediate. This email to be set to auto-send after a pre-set time controllable by octopus (e.g. after 12, 24, 48, 72, or some other suitable number of hours) if No Introducer exists.

### Introduce Email

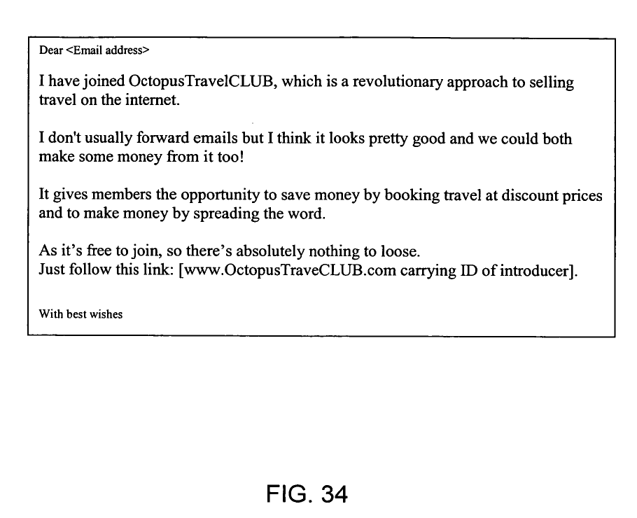

The Introduce Email is illustrated in FIG. 34, has an email type of Web, and a Run Type of Immediate.

### Forgot Password Email

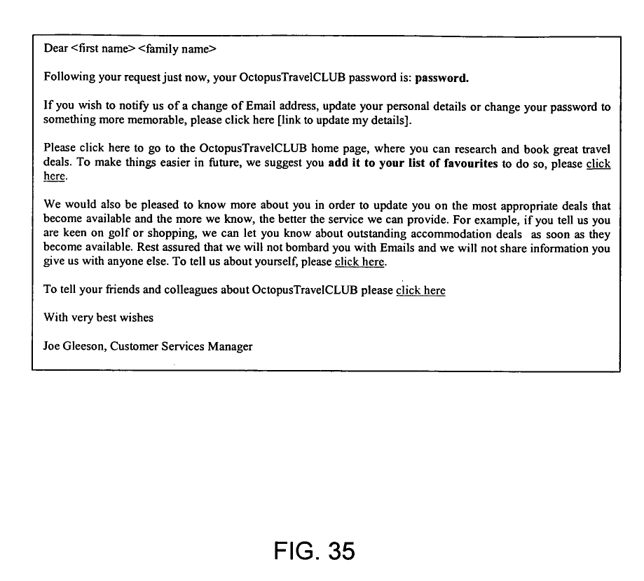

The Forgot Password Email is illustrated in FIG. 35, has an email type of Web, and a Run Type of Immediate.

### Pending Commission Email

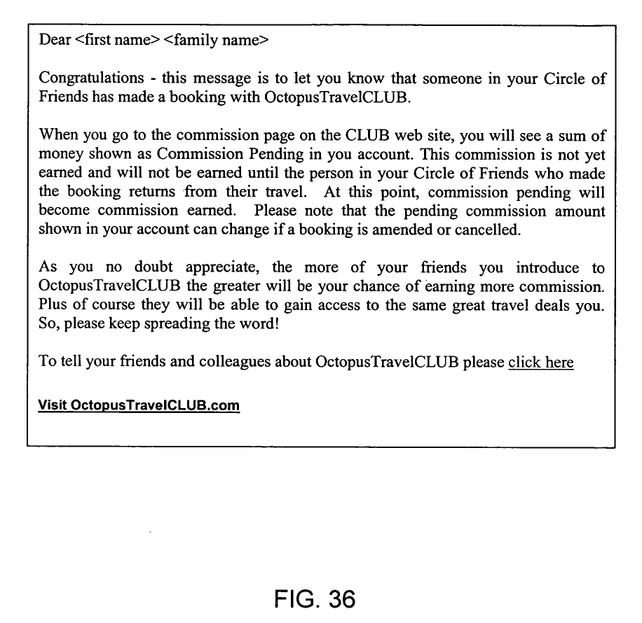

The Pending Commission Email is sent to members that request to be notified when they have commission pending. The default will be set to weekly but this can be changed by user to daily, monthly, never, or some other suitable frequency. Bookings that are confirmed and fully paid will be stored in the email reference file ready for processing. The Pending Commission Email is of Email Type AS400, Run Type Batch (Daily), and is shown in FIG. 36.

### Resign Confirmation Email

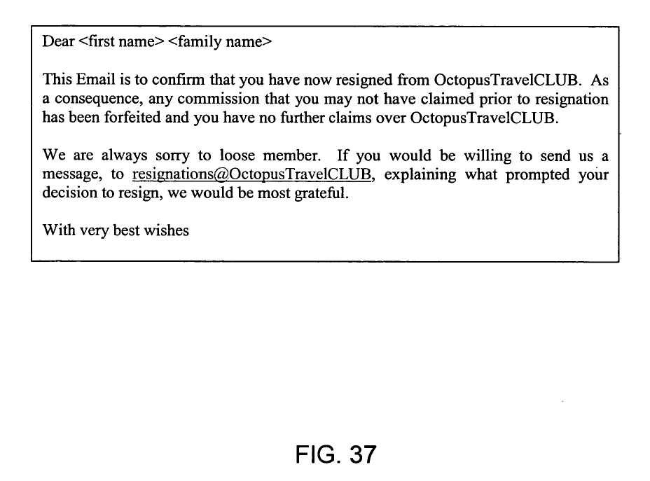

The Resign Confirmation Email is illustrated in FIG. 37, has an email type of Web, and a Run Type of Immediate.

### Customer Services

Customer Services are provided to help answer members' questions and field booking enquiries. Each regional Travel Club is part of an existing site, e.g. Octopus UK. Thus it is possible to view OctopusTravelCLUB bookings through the existing call centre. Should there be a need for OctopusTravelCLUB Customer Services to be separated from all others, this can be managed by login authority to Groups. Similarly, other Call Centre staff can have access to OctopusTravelCLUB bookings removed. All OctopusTravelCLUB Call Centres may be able to view all OctopusTravelCLUB members, but viewing or maintaining booking information may be restricted to each regional Call Centre. For example, OCTUS may not be able to view OCTUK bookings.

The status of a members' account may change, and the following statuses are available:
Active
   The member's account has been registered successfully and is ready for use.
Resigned
   The member has chosen to close his/her account. The email address may be registered again but a new account will be created. This means that the member may not return to his/her original network. Once a member resigns the network will be adjusted so the chain is not broken.
Suspended
   The account may be suspended via the call centre. If an account has been suspended then the member will not be able to log in. The account may not receive any new commission. Pending amounts that change to eligible may not be applied to the account.
   The account may be changed back to ‘Active’. The member will be eligible for commission from the date of activation only.

### Schematic of Customer Services Web Page Flow

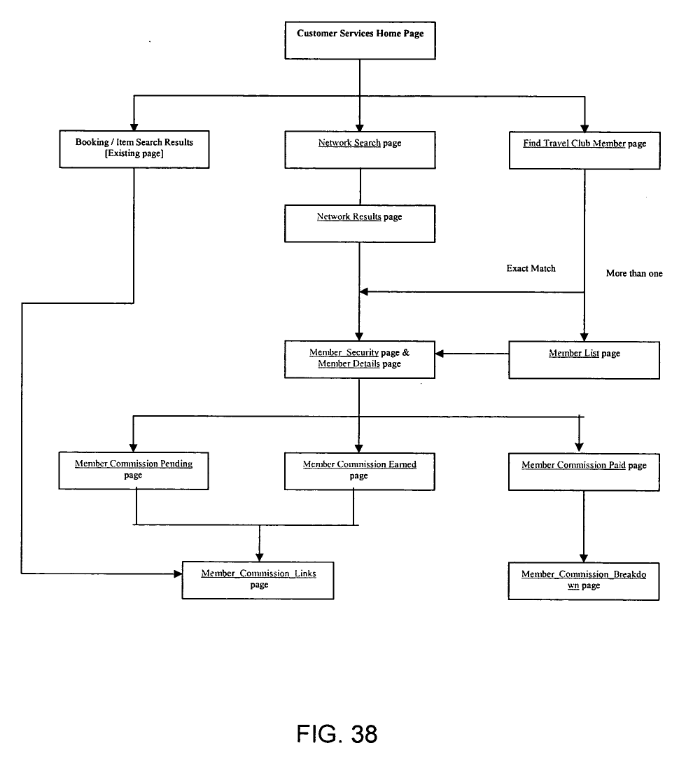

FIG. 38 illustrates a logical flow diagram for Customer Services web page flow, and illustrates the relationship between various web pages associated with Customer Services.

### Commission Changes

All pages that display the commission amount may be changed to provide a link to display the members who may or have received commission. The link references the Member Commission Links Page.

### Find Travel Club Member Page

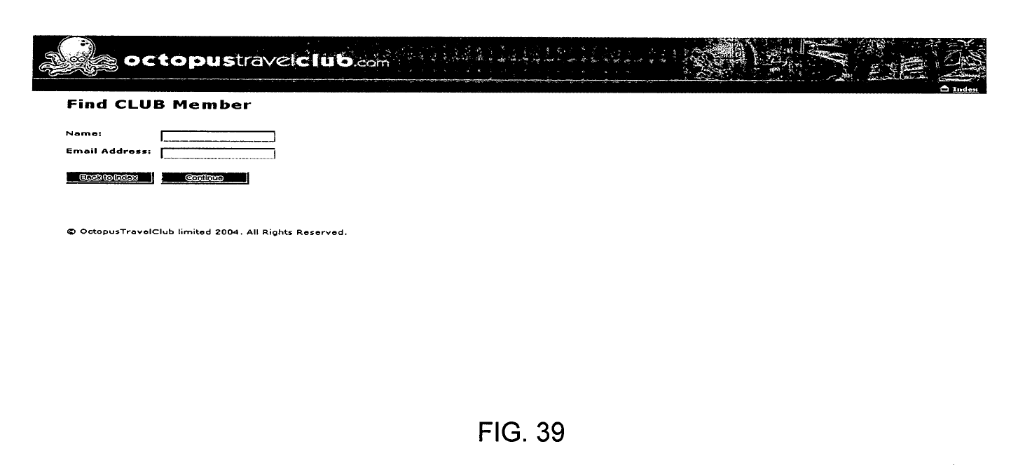

The Find Travel Club Member Page allows participants of OctopusTravel to find other members, and is shown in the screen capture of FIG. 39.

Find Travel Club Member Page Information:

This page will allow various methods of finding a member.
If the results of the search are for more than one member then display the Member List Page; otherwise show the Security Details Page.
User can enter name/part name or email/part email and then the results returned should match the part entered data in similar way to current search function on Booking/Item page.
Box for Membership number may be added to aid call centre staff.

### Member List Page

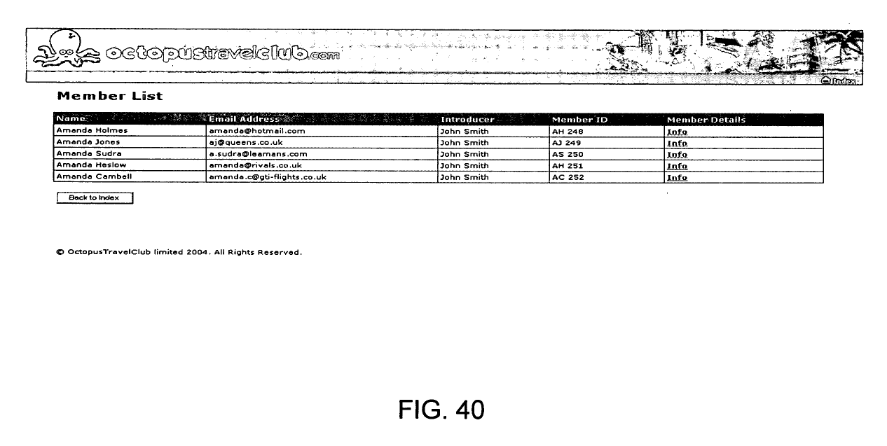

The Member List Page is shown in the screen capture of FIG. 40.

Member List Page Information:

This page will list all of the matches from the find member search.
   Member List Page Links:
Each member will have a link to the Security Details Page.

### Security Details Page

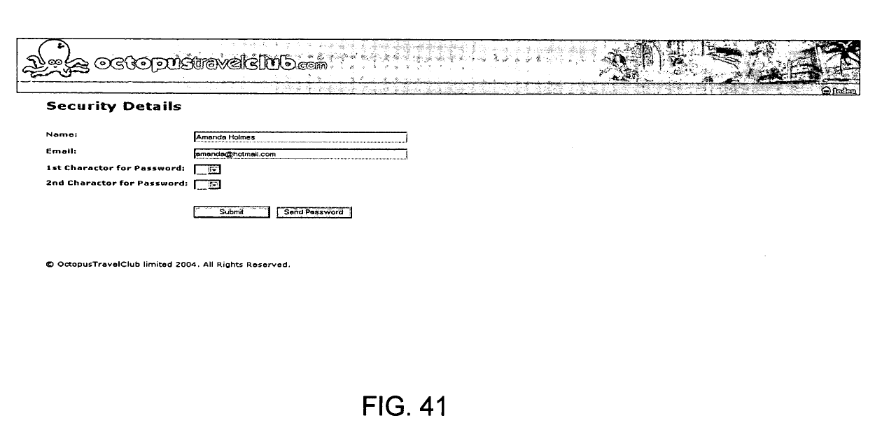

The Security Details Page is shown in the screen capture of FIG. 41.

Security Details Page Information:

This page will prompt answering of security questions.
Password Authentication
   Select two random characters of the member's password.
      Security Details Page Validation:
The client can make 3 attempts to give the correct password. After the third attempt the client will be refused.
   Security Details Page Links:
Submit button will go to the Member Details Page.
Send password will send the Forgot Password Email.

### Member Details Page

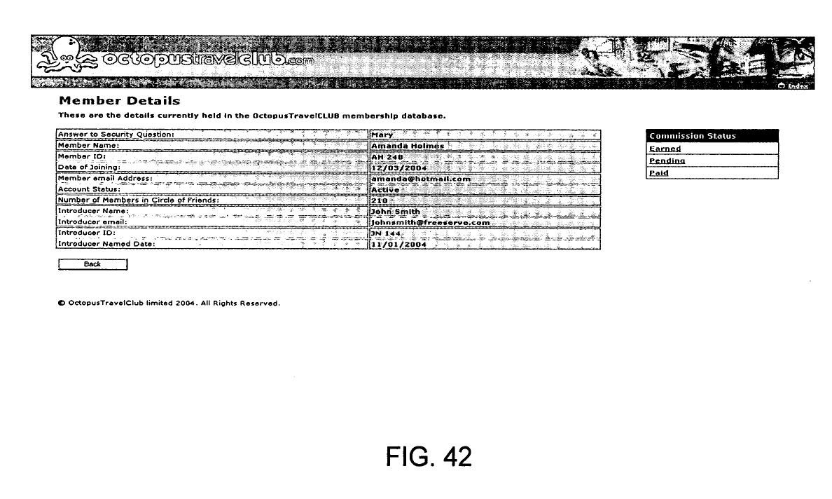

The Member Details Page is shown in the screen capture of FIG. 42.

Member Details Page Information:

The following details illustrate the various status options:
   Status—This is a dropdown box with the values:
      ‘Active’
      ‘Suspended’—Instigated at the decision of the Club in case the member breaks the rules. The member will not be able to receive any commission while suspended, and his/her network will not change. This dropdown will be disabled unless the user has the correct authority. Free format remarks will be displayed and will be able to be changed to note the reason why suspended.
      ‘Resigned’
   Alternative implementations may utilize other designations, such as suspicious activity, under review, or some other suitable designation.
Commission Pending
   Link to the Member Commission Pending Page.
Commission Earned
   Link to the Member Commission Earned Page.
Commission Paid
   Link to the Member Commission Paid Page.

### Member Commission Pending Page

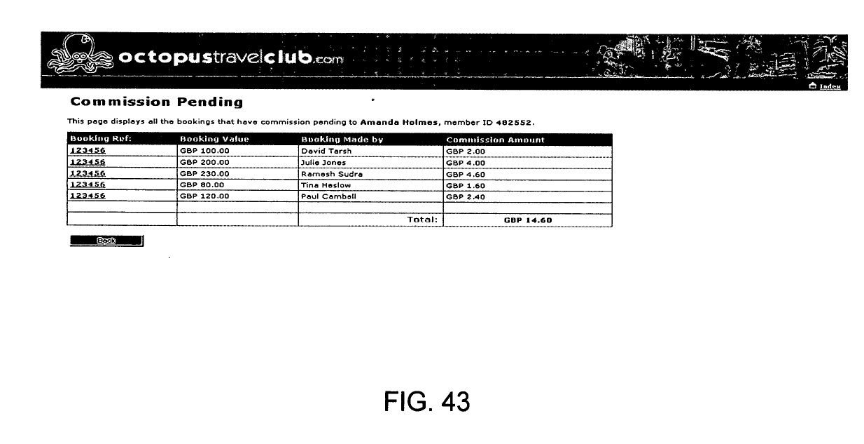

The Member Commission Pending Page is shown in the screen capture of FIG. 43.

Member Commission Pending Page Information:

This page displays all the bookings that have commission pending to that member.
   Member Commission Pending Page Links:
Booking—Link to the Member Commission Links Page.

### Member Commission Earned Page

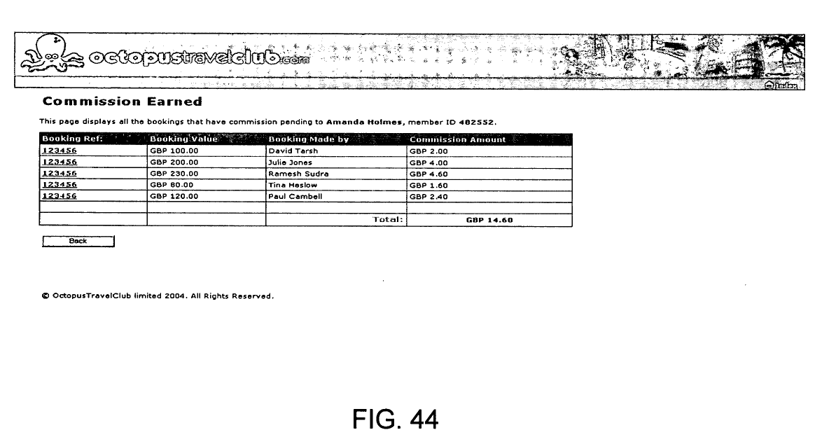

The Member Commission Earned Page is shown in the screen capture of FIG. 44.

Member Commission Earned Page Information:

This page displays all the bookings that have accrued commission to that member.
   Member Commission Earned Page Links:
Booking—Link to the Member Commission Links Page.

### Member Commission Paid Page

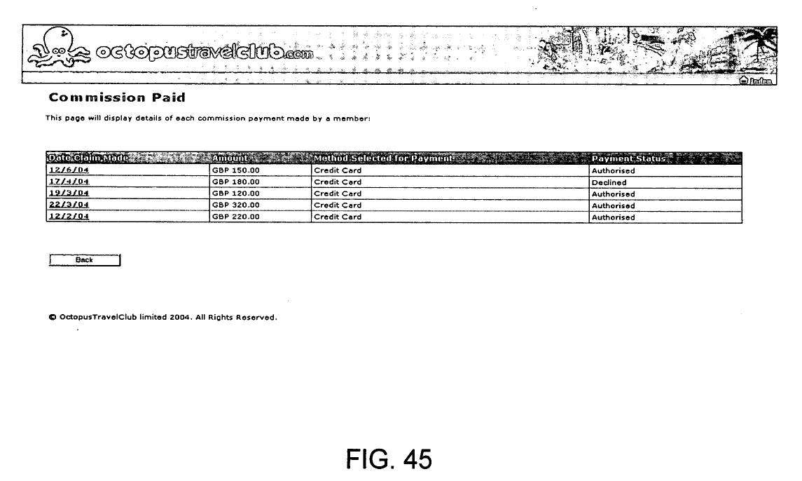

The Member Commission Paid Page is shown in the screen capture of FIG. 45.

Member Commission Paid Page Information:

This page displays details of each commission payment claimed by a member.
There can be date range selection boxes that will be used to restrict the amount of claims to be displayed. The ‘from date’ can default to 12 months prior to the current date. While 12 months can be used, 3 months, 6 months, 18 months, or some other suitable number could also be used.
   Member Commission Paid Page Links:
Date of Claim—Link to the Member Commission Payments Breakdown Page.

### Member Commission Payments Breakdown Page

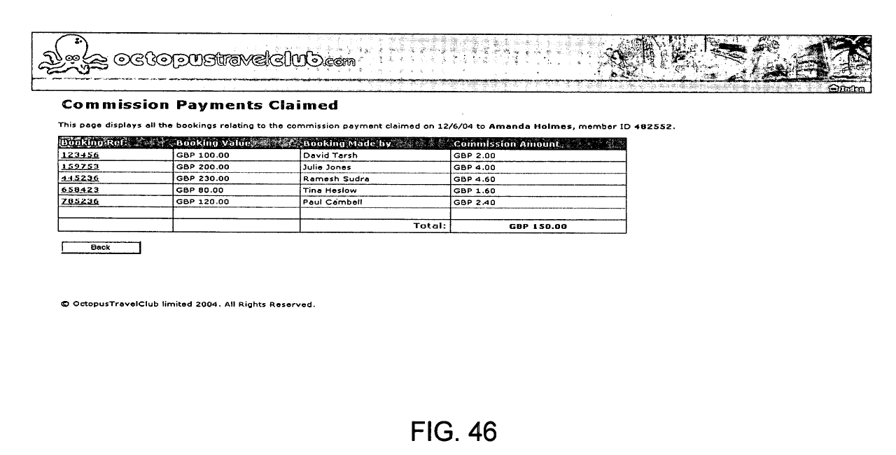

The Member Commission Payments Breakdown Page is shown in the screen capture of FIG. 46.

Member Commission Payments Breakdown Page Information:

This page displays he bookings associated with the commission payment.

### Member Commission Links Page

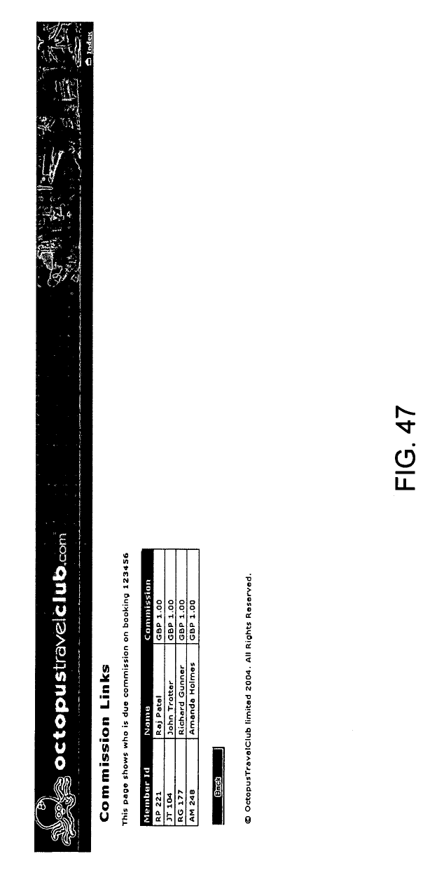

The Member Commission Links Page is shown in the screen capture of FIG. 47.

Member Commission Links Page Information:

This page displays the members who may or have received commission on a booking.

### Network Search Page

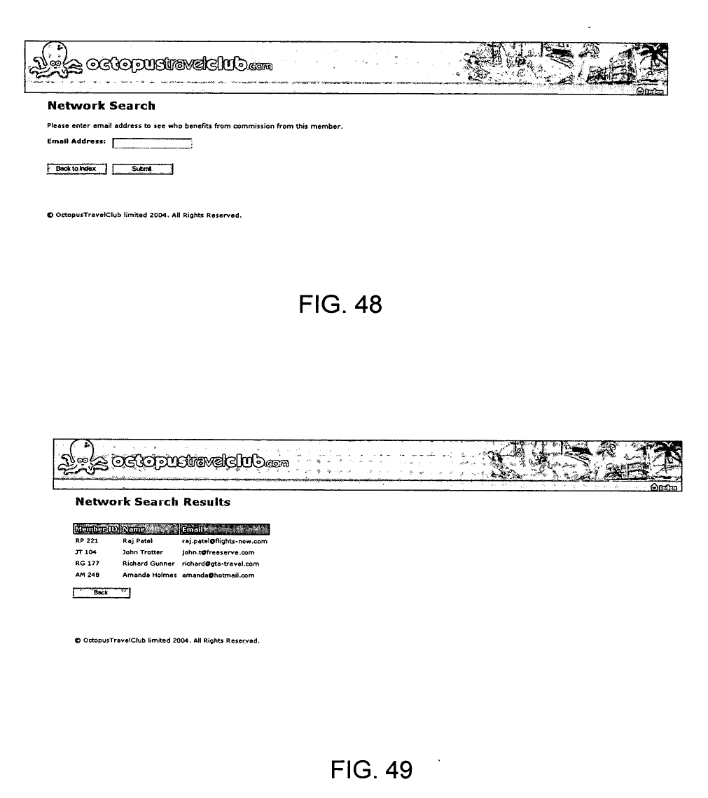

The Network Search Page is shown in the screen capture of FIG. 48.

Network Search Page Links:

Submit button will call the Network Results List Page.

### Network Results List Page

The Network Results List Page is shown in the screen capture of FIG. 49.

Network Results List Page Information:

This page list the introducers associated with the member(s) from the Network Search Page.
   Network Results List Page Links:
Each Member ID will have a link to the Security Details Page.

### OctopusTravelCLUB Database

One or more databases may be used with the octopustravelclub.com embodiment of the present invention. Each of the one or more databases may be operative on the computer system described in FIG. 1.

The database is a global database, and each regional site is linked to it as club members within any particular member's network may fall within many geographic regions.

Various member information may be stored in the one or more databases, including:

Member Information Used:
Membership number
Email address
Name (first name, surname)—To be held as 2 separate fields
Status (Active/Resigned/Suspended)
Last login date and time
Failed login attempt date and time
Login Failure counter
Password
Security Question
Answer to security question
Date registered
Country of residence
Preferred currency
Introducer's membership number
Commission Available/Earned
Commission Pending
Commission Claimed
Claimed Amount—History of transactions
Network information: Number of members in network
Whether the member uses any notification of any new bookings made
   Interval (Never, Daily, Weekly, Monthly)
Email History—Selected Emails only (Everything but notification)
Number of emails sent and when through the Introduce a Friend page.
Standard Audit Trail

Personal Information:
Address: lines 1, 2, 3, country, post code
Phone 1, Phone 2
Date of Birth—Year of Birth for US residents
Gender
Marital Status
No. of Children
Preferred Hotel Star Rating
Occupation—List to be determined by site
Interests ( )—List to be determined by site
‘How did you hear about us’
Customer Services Remarks (Free format entry)

Booking Information Used:
Member who made the booking
Members to be paid (List of introducers)

### OctopusTravelCLUB Web Tracking

Data tracking methods may be applied throughout the site and from the Local Homepage. On exclusive offers the site will track the click for each offer, returning:
Title (e.g. City Breaks)
Date
Time

Tracker code can be inserted on the static HTML pages (landing pages), returning:
Filename (CityBreaks_Paris.htm)
Date
Time
Each click on that page (by name)

### Client Booking Report (Existing Report)

The Client Booking Report (Existing Report) report shows the total amount of commission for all members, and includes all statuses whether the commission is Pending, Earned, or Claimed. These totals must be shown separately for Pending, Earned, and Claimed to assess commission liabilities for accounting purposes.

### Daily Member Joiners

The Daily Member Joiners Report shows the daily number of new joiners.

The following report selection will be available:
Country
Date (Month/Year)
Create as (Web/File)
Break on country (Tick Box)

The report can contain the following information:
Selection Criteria can appear at the top of the report.
The main information can be of the same format as OctopusTravel's ‘Daily Turnover Report’.

### Staff Claims Report

The following report selection is available:
Company (Octopus or GTA) and ‘All’
Office
From Date
To Date

The Staff Claims Report shows the commission claims made by members of staff.

The report will contain the following information:
Company (Octopus or GTA) and ‘All’
Office
Member Name
Payroll Number
Claim Date
Amount
Currency

### OctopusTravelCLUB Membership Rules

For illustrative purposes only, the following set of member rules is provided to illustrate the membership rules of one embodiment of the present invention. The rules below begin with an Introduction section and end with a miscellaneous section.

Introduction
These rules govern membership of OctopusTravelCLUB. They are designed to protect the integrity of the CLUB and it members. Please read them carefully so you know what you are agreeing to when you join. If you do not agree to them, please do not register.
As a member of OctopusTravelCLUB your benefits include access to exclusive discounts on over 20,000 hotels around the world and on other travel services, plus the opportunity to earn commission on bookings made by people that you introduce directly and indirectly to the CLUB.

Definitions
OctopusTravel—OctopusTravel.com Limited (registered number: 3963097), a member of The Association of British Travel Agents (ABTA) carrying on business at 27 Goswell Road, London, EC1M 7GT, England.
OctopusTravelCLUB, also referred to as the CLUB—is the name given to the service described and promoted at www.OctopusTravelCLUB.com (“the Site”). It is owned and operated by OctopusTravel. It is designed to promote the services of OctopusTravel, which include the sale of hotel accommodation, rented villas and apartments, sightseeing, transfers and other travel services.
Member—a person whose application for membership made through the Site is accepted by OctopusTravel.
Introducer—a Member is to be considered as an Introducer as regards any other Member if that other Member identified him or her as their Introducer when joining OctopusTravelCLUB.
Level—as regards any one Member, “First Level Members” refers to those Members who have named him or her as their Introducer, and Members for whom one of these first level Members is the Introducer are “Second Level Members”. In a similar way there can be Third, Fourth and Fifth Level Members. First to Fifth Level Members will be treated as having been introduced, directly or indirectly, by the Member.
Circle of Friends—the First to Fifth Level Members introduced directly and indirectly by an Introducer and who, on making a booking, will cause that Introducer to earn commission under the OctopusTravelCLUB rules.

Membership Rules
The OctopusTravelCLUB membership rules incorporate OctopusTravel's Booking Terms, Site Terms and Privacy Statement. Between them, these documents form the entire agreement between you and OctopusTravel regarding your membership of OctopusTravelCLUB.
As a Member, you agree to be bound by these rules.

Becoming a Member
Membership of OctopusTravelCLUB is free of charge. Members have no financial obligation in respect of their membership.
Membership of OctopusTravelCLUB is open to individuals over the age of 18. It is not open to associations or corporations.
Membership is open to individuals living anywhere in the world but OctopusTravelCLUB is UK based and membership is governed by English law.
OctopusTravel reserves the right to reject any application for membership of OctopusTravelCLUB.
Membership commences immediately upon acceptance by OctopusTravel of a membership application. Membership will be confirmed by email and a copy of these rules will be provided to each Member on the Site.
A Member may only nominate one Introducer on the membership application. Once OctopusTravelCLUB has confirmed that the named Introducer is already a member, a Member may not change the name of their Introducer.
If the Email address of the prospective Introducer is not entered or is incorrectly entered by the Member at the time of applying for membership, the prospective Introducer will have no claim on any commissions that might otherwise flow.
Membership of OctopusTravelCLUB and the benefits of membership are personal to the Member and are not transferable and may not be sub-licensed or assigned.
An individual may have only one membership.
Members should only introduce to OctopusTravelCLUB people that they know personally and whom they know would be happy to receive an email from the Member about OctopusTravelCLUB.

Passwords
Each new Member will be asked to create a password. Members must keep this password confidential and must not disclose it or share it with anyone. Members are responsible for all activities and orders that occur or are submitted under their login and password. If a Member knows or suspects that someone else knows their password they must immediately notify OctopusTravel by contacting CustomerServices@OctopusTravelCLUB.com, Tel: (phone number to be inserted).
If OctopusTravel has reason to believe that there is likely to be a breach of security or misuse of the Club, we may use a Member to change their password and/or suspend that Member's account.

Members Benefits
Benefits available at any given time to Members will be published on the Site. Once they are removed from the Site, they will cease to be available.

Obtaining Commission
A Member becomes eligible to receive commission by virtue of another Member within his or her Circle of Friends booking, paying for and using a service via the OctopusTravelCLUB.com website. The commission due to Introducers as a result of such activity by Members is explained further within the Frequently Asked Questions section of the Site.
Members are not entitled to any commission merely for the introduction of other Members.
Please note that to allow commission to be given to any Introducer, bookings must be made on www.OctopusTravelCLUB.com. This also ensures that the Member benefits from special membership rates. For the avoidance of doubt, bookings made on the www.OctopusTravel.com will not earn commission.
It is illegal for a promoter or a participant in a trading scheme to persuade anyone to make a payment by promising benefits from getting others to join a scheme.
OctopusTravelCLUB does not claim that large amounts of commission are easily achieved. Do not be misled by claims that high earnings are easily achieved.
When Members log in to their personal, on-line account using their password, they are able to see how much commission they have accumulated. For privacy reasons, who has made a booking or what the booking was for is not identified. Commission will be identified within 2 categories:
Commission Earned—is the commission for services that have been booked, paid for and used by the Member's Circle of Friends.
Commission Pending—is commission for services booked and paid for by the Member's Circle of Friends, but which have not yet been used. These bookings could still be changed or cancelled, which would affect the amount of commission pending. After the member has used the service, the status of the commission will change to Commission Earned.
Members are expressly forbidden from receiving commission on any booking made by them or directly or indirectly for their own benefit (i.e. for any service used by the Member). If OctopusTravel discovers that a Member has received or is attempting to receive commission on such a booking, OctopusTravel may terminate the Member's membership immediately. On termination any unredeemed commission that the Member has received will cease to be redeemable.
Once a Member's account shows the value of Commission Earned to be at least £25 (or an equivalent amount in local currency using the exchange rate used by OctopusTravelCLUB), the Member can redeem that commission by submitting a payment of commission request form on the website within the “Your CLUB Membership” section.
If the Member is based in the USA, commission will be paid directly into the Member's bank account. Elsewhere in the world, it is paid to the Member's Visa or MasterCard credit card account. At present, these are the only payment methods.
Any commission that has not been redeemed three years after it has accrued ceases to be redeemable and will be automatically removed from that Member's account.

Taxation
The Member warrants that he/she is not registered for VAT or for any sales tax in any jurisdiction.
OctopusTravel and OctopusTravelCLUB will not be liable to pay any income tax, National Insurance or any other tax that may be incurred by Members as a consequence of their receiving commission as Members.
The Member will be wholly responsible for reporting his/her commission to any relevant government or local authority and for paying any sum that may be due and will hold OctopusTravel and OctopusTravelCLUB free from any such liability.
An exception to this rule on taxation exists in the case of employees of OctopusTravel and Gullivers Travel Associates. In their case, any commission that is earned and claimed during their period of employment will be treated as employment-related remuneration and will be taxed accordingly.

Communication Between OctopusTravelCLUB and its Members
It is the responsibility of Members to keep their Email address and other contact details up to date.
Communications sent to Members will be deemed delivered if posted to a mailing address or Emailed to an Email address on record with OctopusTravelCLUB.
OctopusTravel and OctopusTravelCLUB will not be held responsible for any delay due to misdirected or lost mail.

Amendment to the Rules
OctopusTravel may change the OctopusTravelCLUB rules from time to time and when doing so will always try to give notice.
Any changes will have effect immediately they are posted on the Site. It is the responsibility of Members to check the OctopusTravelCLUB website regularly for any changes to the rules.
In the event of any amendment to the rules of OctopusTravelCLUB membership, continued use of OctopusTravelCLUB by a Member will be deemed an acceptance of the rules as amended.
OctopusTravel and OctopusTravelCLUB is not liable to Members in any way for any value or benefits Members may lose as a result of any changes made to the OctopusTravelCLUB.

Termination of Membership
OctopusTravel may terminate the membership of any Member without giving any notice, if the Member:
Sends Emails about OctopusTravelCLUB to people he does not know personally (ie: if the Member ‘spams’ others);
Does or says anything that could reasonably be considered to bring OctopusTravelCLUB or OctopusTravel in to disrepute;
Does or says anything that could reasonably be considered likely to damage the business of OctopusTravel or of OctopusTravelCLUB;
Has or attempts to have more than one membership;
Becomes or attempts to become a Member in the name of another person;
Applies for membership or joins OctopusTravelCLUB on behalf of another person without that person's express written permission; or
Receives or attempts to receive commission on any booking made by them or directly or indirectly for their own benefit.
If a Member's account is inactive for 12 consecutive months, the Member's membership may be terminated at the discretion of OctopusTravel. In this context, inactive means that no commission has been earned, the Member's Group of Friends has not grown and the Member has not made a booking.
For the avoidance of doubt, termination will not alter the relationship between Members at levels above or below the Member whose membership has been terminated.
Members are free to resign from OctopusTravelCLUB at any time without penalty. Termination can be effected, either by following the relevant instructions in the Update/Change Profile section on the Site or by sending written notification, 14 days in advance, to OctopusTravelCLUB, 27 Goswell Road, London EC1M 7GT. Any Commission Earned worth at least £25 must be claimed prior to termination.
Membership will terminate automatically upon the death of the Member.
Upon termination any unredeemed commission worth less than £25 will cease to be redeemable and all rights to benefits or to receive or redeem commission will cease.
OctopusTravel may terminate the OctopusTravelCLUB at any time, although it will always try to give reasonable notice.
A new Member may:
(i) within 14 days of entering into the agreement, cancel his or her membership without penalty and will have the right to recover any monies which he has paid to or for the benefit of OctopusTravel or any Members of OctopusTravelCLUB in connection with joining OctopusTravelCLUB;
(ii) within 14 days of entering into the agreement, return to 27 Goswell Road, London EC1M 7GT, any goods the Member has purchased within that period from OctopusTravelCLUB and which remain unsold—provided that such unsold goods remain in the condition in which they were in at the time of purchase, whether or not their external wrappings have been broken and to recover any monies paid in respect of such goods;
(iii) within 14 days of entering into the agreement, cancel any services ordered within that period from OctopusTravelCLUB and recover any monies paid in respect of such services not yet supplied to the Member;
and OctopusTravelCLUB shall not be entitled to make a handling charge in respect of goods returned under sub-paragraph (ii) above or services cancelled under sub-paragraph (iii) above. 1

Data Protection
Members will be able to identify if someone that they have introduced to the CLUB has joined and has identified that Member as their Introducer. Members expressly consent to the disclosure to their Introducer of the fact that they have joined OctopusTravelCLUB.
In order to comply with data protection requirements, Members will not be permitted access to any further information about other Members or their Introducers or of the identity of Members for which they earn commission on other Levels.
OctopusTravel may, from time to time, send Members administrative, marketing and other messages about OctopusTravelCLUB and about OctopusTravel's products and services.

Miscellaneous
These terms are governed by English law and subject to the non-exclusive jurisdiction of the English courts.
If any provision of these terms is found to be invalid by any court having competent jurisdiction, the invalidity of that provision will not affect the validity of the remaining provisions of these terms, which shall remain in full force and effect.
If a Member breaches these rules and OctopusTravel ignores this, OctopusTravel will still be entitled to use its rights and remedies at a later date.
A person who is not a party to these terms shall have no right under Contract (Rights of Third Parties) Act 1999 to enforce any term or condition of these terms but this shall not affect any right or remedy of a third party which exists or is available apart from that Act.

While the present invention has been described in detail in connection with exemplary embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. In particular, the specific embodiments of the network marketing method described above should be taken as exemplary and not limiting. Accordingly, the present invention is not limited by the foregoing description or drawings, but is only limited by the scope of the appended claims.

I claim:

1. A method for network marketing which furnishes rewards based on consumer purchases, comprising the steps of:
a. participating in a marketing network by an introducer;
b. communicating a recommendation from the introducer to a first consumer;
c. providing identification information by the first consumer to identify the introducer;
d. making a purchase by the first consumer based on the recommendation;
e. determining a reward to provide to the introducer based on the purchase; and
f. furnishing the reward to the introducer.

2. The method of claim 1, wherein participants bear no financial costs at any time to participate in the network.

3. The method of claim 1, wherein the recommendation is a recommendation to participate in the network.

4. The method of claim 1, wherein the recommendation is a purchase recommendation.

5. The method of claim 4, wherein the purchase recommendation is for at least one of a particular product, a product brand, or a product vendor.

6. The method of claim 1, wherein the communicating step comprises communicating a recommendation orally from the introducer to a first consumer.

7. The method of claim 1, wherein the communicating step comprises communicating a recommendation electronically from the introducer to a first consumer.

8. The method of claim 1, wherein the communicating step comprises communicating a recommendation by email from the introducer to a first consumer.

9. The method of claim 1, wherein the purchase is for one or more goods or services.

10. The method of claim 1, wherein the purchase includes at least one travel service.

11. The method of claim 10, wherein the travel service includes at least one of a hotel booking, flight booking, vacation package booking, rail booking, or cruise booking.

12. The method of claim 1, wherein the identification information includes one or more of an email address, name, login, password, or keyword.

13. The method of claim 1, wherein the providing step comprises the step of providing identification information by the first consumer to identify the introducer, wherein the identification information is input by the first consumer into a computing device.

14. The method of claim 13, wherein the identification information is input into a web browser operating on the computing device.

15. The method of claim 1, wherein the reward includes at least one of points, incentives, special offers, discounts, frequent flier miles, a free product, a free service, credit, Credit Funds Transfer, or currency.

16. The method of claim 1, wherein the determining step comprises determining a reward to provide to a second participant based on a proximity of the second participant to the introducer.

17. The method of claim 1, wherein the determining step comprises:
a. computing a commission based on the purchase; and
b. determining a reward to provide to the introducer based on the commission.

18. The method of claim 17, wherein the commission is one of a percentage based on the cost of the purchase, a fixed amount, a deferred amount, or a conditional amount.

19. The method of claim 17, wherein the commission is a percentage based on the cost of the purchase and the reward is in a currency.

20. The method of claim 17, wherein the percentage is two percent.

21. The method of claim 1, wherein the furnishing step comprises furnishing the reward to the introducer only if the reward exceeds a predetermined value.

22. The method of claim 21, wherein the predetermined value is a predetermined currency value.

23. The method of claim 1, further comprising the step of automatically sending an email to the introducer upon the occurrence of a predetermined event, wherein predetermined events include provision of identification information by the first consumer identifying the introducer, determination of the reward for the introducer, furnishing the reward to the introducer, achievement of a certain reward level by a participant, and addition of an new participant to the network.

24. A method for network marketing which furnishes rewards based on consumer purchases, comprising the steps of:
a. participating in a marketing network by an introducer;
b. associating the introducer with a first consumer;
c. participating in the marketing network by the first consumer;
d. communicating a first recommendation from the first consumer to a second consumer;
e. providing a first identification information by the second consumer to identify the first consumer;
f. making a first purchase by the second consumer based on the first recommendation;
g. determining a first reward to provide to the introducer based on the first purchase and a second reward to provide to the first consumer based on the first purchase; and
h. furnishing the first reward to the introducer and furnishing the second reward to the first consumer.

25. The method of claim 24, wherein participants bear no financial costs at any time to participate in the network.

26. The method of claim 24, wherein the recommendation is a recommendation to participate in the network.

27. The method of claim 24, wherein the recommendation is a purchase recommendation.

28. The method of claim 24, wherein the first recommendation is for at least one of a particular product, a product brand, or a product vendor.

29. The method of claim 24, wherein the communicating step comprises communicating a first recommendation orally from the first consumer to the second consumer.

30. The method of claim 24, wherein the communicating step comprises communicating a first recommendation electronically from the first consumer to the second consumer.

31. The method of claim 24, wherein the communicating step comprises communicating a first recommendation by email from the first consumer to the second consumer.

32. The method of claim 24, wherein the first purchase is for one or more goods or services.

33. The method of claim 24, wherein the first purchase includes at least one travel service.

34. The method of claim 33, wherein the travel service includes at least one of a hotel booking, flight booking, vacation package booking, rail booking, or cruise booking.

35. The method of claim 24, wherein identification information includes one or more of an email address, name, login, password, or keyword.

36. The method of claim 24, wherein the providing step comprises the step of providing a first identification information by the second consumer to identify the first consumer, wherein the first identification information is input by the second consumer into a computing device.

37. The method of claim 36, wherein the first identification information is input into a web browser operating on the computing device.

38. The method of claim 24, wherein the first reward and the second reward each includes at least one of points, incentives, special offers, discounts, frequent flier miles, a free product, a free service, credit, Credit Funds Transfer, or currency.

39. The method of claim 24, wherein the first reward and the second reward are the same.

40. The method of claim 24, wherein the first reward and the second reward are different.

41. The method of claim 24, wherein the determining step comprises:
a. computing a first commission based on the first purchase;
b. computing a second commission based on the first purchase;
c. determining a first reward to provide to the introducer based on the first commission; and
d. determining a second reward to provide to the first consumer based on the second commission.

42. The method of claim 41, wherein each commission is one of a percentage based on the cost of the purchase, a fixed amount, a deferred amount, or a conditional amount.

43. The method of claim 41, wherein the first commission and the second commission are each a percentage based on the cost of the first purchase, and the first reward and the second reward are each in a currency.

44. The method of claim 41, wherein the percentage is two percent.

45. The method of claim 24, wherein the associating step comprises the steps of:
a. providing a second identification information by the first consumer to identify the introducer; and
b. associating the introducer with the first consumer.

46. The method of claim 24, wherein the associating step comprises the steps of:
a. communicating a second recommendation from the introducer to the first consumer;
b. providing a second identification information by the first consumer to identify the introducer;
c. making a second purchase by the first consumer based on the second recommendation;
d. determining a third reward to provide to the introducer based on the second purchase; and
e. furnishing the third reward to the introducer.

47. The method of claim 24, wherein the furnishing step comprises furnishing the first reward to the introducer and furnishing the second reward to the first consumer only if the first reward and the second reward each exceed a predetermined value.

48. The method of claim 47, wherein the predetermined value is a predetermined currency value.

49. The method of claim 24, further comprising the step of automatically sending an email to the introducer upon the occurrence of a predetermined event, wherein predetermined events include provision of identification information by the second consumer identifying the first consumer, determination of the first reward, determination of the second reward, furnishing the first reward, furnishing the second reward, achievement of a certain reward level by a participant, or addition of a new participant to the network.

50. A method of network marketing which furnishes rewards based on consumer purchases, comprising the steps of:
a. creating a chain of introduction consisting of a plurality of members, wherein each member in the chain of introduction is associated with another member who is above them in the chain of introduction by virtue of being that member's respective introducer;
b. communicating a recommendation from a first member to a consumer, wherein the first member is one of the plurality of members in the chain of introduction;
c. providing identification information by the consumer to identify the first member;
d. making a purchase by the consumer based on the recommendation;
e. determining a predetermined number of members in the chain of introduction above the first member in order to form a chain of rewards, wherein the chain of rewards is a subset of the chain of introduction;
f. determining a reward to provide to each member in the chain of rewards based on the purchase; and
g. furnishing the determined reward to each member in the chain of rewards.

51. The method of claim 50, wherein members bear no financial costs at any time to participate in the network.

52. The method of claim 50, wherein the recommendation is a recommendation to participate in the network.

53. The method of claim 50, wherein the recommendation is a purchase recommendation.

54. The method of claim 53 wherein the purchase recommendation is for at least one of a particular product, a product brand, or a product vendor.

55. The method of claim 50, wherein the communicating step comprises communicating a recommendation orally from a first member to a consumer.

56. The method of claim 50, wherein the communicating step comprises communicating a recommendation electronically from a first member to a consumer.

57. The method of claim 50, wherein the communicating step comprises communicating a recommendation by email from a first member to a consumer.

58. The method of claim 50, wherein the purchase is for one or more goods or services.

59. The method of claim 50, wherein the purchase includes at least one travel service.

60. The method of claim 59, wherein the travel service includes at least one of a hotel booking, flight booking, vacation package booking, rail booking, or cruise booking.

61. The method of claim 50, wherein identification information includes one or more of an email address, name, login, password, or keyword.

62. The method of claim 50, wherein the reward includes at least one of points, incentives, special offers, discounts, frequent flier miles, a free product, a free service, credit, Credit Funds Transfer, or currency.

63. The method of claim 50, wherein the determining step comprises determining a reward to provide to each member in the chain of rewards based on each member's proximity in the chain of rewards to the first member.

64. The method of claim 63, wherein the reward is a percentage based on the cost of the purchase.

65. The method of claim 63, wherein the reward is a percentage based on the cost of the purchase and the reward is in a currency.

66. The method of claim 65, wherein the percentage is two percent.

67. The method of claim 63, wherein the reward is a fixed amount.

68. The method of claim 50, further comprising the step of automatically sending an email to one or more members in the chain of introduction upon the occurrence of a predetermined event, wherein predetermined events include providing identification information identifying a member, determination of a reward for a member, furnishing a reward to a member, achievement of a certain reward level by a member, and addition of an new member to the network.

69. The method of claim 50, wherein no member in the chain of introduction can change their respective introducer.

70. The method of claim 50, wherein the predetermined number of members is five.
